(19) United States
(12) Patent Application Publication
(10) Pub. No.: US 2020/0361280 A1
(43) Pub. Date: Nov. 19, 2020

(54) TEMPERATURE ADJUSTMENT SYSTEM FOR ELECTRIC MOTOR VEHICLE

(71) Applicant: AISIN SEIKI KABUSHIKI KAISHA, Kariya-shi (JP)

(72) Inventor: Atsunori HASHIMOTO, Kariya-shi (JP)

(73) Assignee: AISIN SEIKI KABUSHIKI KAISHA, Kariya-shi (JP)

(21) Appl. No.: 16/818,888

(22) Filed: Mar. 13, 2020

(30) Foreign Application Priority Data
May 15, 2019 (JP) 2019-091854

(51) Int. Cl. B60H 1/00; B60H 1/32

(52) U.S. Cl. CPC B60H 1/00392; B60H 1/00278; B60H 1/00428; B60H 1/00735; B60H 2001/3283; B60H 1/3211; B60H 1/32281; B60H 2001/3266; B60H 2001/3282; B60H 1/00885

(57) ABSTRACT

An electric motor vehicle temperature adjustment system includes: an air conditioning refrigerant circuit including a compressor compressing a refrigerant, an air conditioning evaporator provided upstream of the compressor, and an air-cooled condenser condensing the refrigerant flowing out of the compressor with outside air; a battery cooling circuit including a battery evaporator and configured to flow cooling water cooling a main battery; an electric component cooling circuit provided separately from the battery cooling circuit, and including an electric component radiator; a first switching unit configured to perform switching between connection and disconnection of the battery cooling circuit and the electric component cooling circuit; and a motor cooling circuit provided separately from the battery cooling circuit and the electric component cooling circuit and configured to flow cooling water that cools a motor.

### CROSS REFERENCE TO RELATED APPLICATIONS

This application is based on and claims priority under 35 U.S.C. § 119 to Japanese Patent Application 2019-091854, filed on May 15, 2019, the entire contents of which are incorporated herein by reference.

### TECHNICAL FIELD

This disclosure relates to a temperature adjustment system for an electric motor vehicle, and more particularly to an electric motor vehicle temperature adjustment system including a battery cooling circuit.

### BACKGROUND DISCUSSION

In the related art, there has been known an electric motor vehicle temperature adjustment system including a battery cooling circuit (see, e.g., JP 2017-105425A (Reference 1)).

Reference 1 discloses a vehicle battery cooling system (electric motor vehicle temperature adjustment system) including a battery cooling line (battery cooling circuit). This vehicle battery cooling system includes another cooling line.

The battery cooling line of Reference 1 is provided with a battery module and a chiller. The other cooling line is provided with an electric component, a motor, and an electric component radiator. Further, cooling water for cooling the battery module flows through the battery cooling line. In the chiller, the cooling water for cooling the battery module is cooled by a refrigerant. Cooling water for cooling the electric component and the motor flows through the other cooling line.

In the vehicle battery cooling system of Reference 1, the battery module is cooled by the cooling water cooled in the chiller in the battery cooling line. Further, in the vehicle battery cooling system, the electric component and the motor are cooled by the cooling water cooled by the electric component radiator in the other cooling line.

However, in the vehicle battery cooling system of Reference 1, the battery module is cooled separately from the electric component and the motor, while the motor is cooled by the cooling water after cooling the electric component and therefore, the temperature adjustment of the motor is difficult. Further, when priority is given to the temperature adjustment of the motor, the temperature adjustment of the electric component becomes difficult. As a result, in this vehicle battery cooling system, it is difficult to adjust the battery module (main battery) to a desired temperature range and at the same time, to adjust each of the electric component and the motor to a separate desired temperature range.

Thus, a need exists for an electric motor vehicle temperature adjustment system which is not susceptible to the drawback mentioned above.

### SUMMARY

An electric motor vehicle temperature adjustment system according to an aspect of this disclosure includes an air conditioning refrigerant circuit including a compressor configured to compress a refrigerant, an air conditioning evaporator provided upstream of the compressor, and an air-cooled condenser configured to condense the refrigerant flowing out of the compressor with outside air, the air conditioning refrigerant circuit being configured to flow the refrigerant that cools air-conditioning air, a battery cooling circuit including a battery evaporator and configured to flow cooling water that cools a main battery provided separately from an auxiliary battery, an electric component cooling circuit provided separately from the battery cooling circuit, including an electric component radiator, and configured to flow cooling water that cools an electric component, a first switching unit configured to perform switching between connection and disconnection of the battery cooling circuit and the electric component cooling circuit, and a motor cooling circuit provided separately from the battery cooling circuit and the electric component cooling circuit and configured to flow cooling water that cools a motor, wherein the motor cooling circuit and the electric component cooling circuit are arranged independently of each other in a state where the cooling water does not flow therebetween. Here, an electric motor vehicle is a broad concept including not only an electric vehicle but also a hybrid vehicle having a drive motor and an engine, a plug-in hybrid vehicle, and a vehicle having a range extender.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram of an electric motor vehicle temperature adjustment system according to a first embodiment;

FIG. 2 is a schematic diagram illustrating a state where an electric component waste heat storage processing and a heater warm-up processing are being performed in the electric motor vehicle temperature adjustment system according to the first embodiment;

FIG. 3 is a schematic diagram illustrating a state where an electric component waste heat storage processing and a battery heat retention processing are being performed in the electric motor vehicle temperature adjustment system according to the first embodiment;

FIG. 4 is a schematic diagram illustrating a state where an electric component heat storage warm-up processing is being performed in the electric motor vehicle temperature adjustment system according to the first embodiment;

FIG. 5 is a schematic diagram illustrating a state where a battery weak cooling processing is being performed in the electric motor vehicle temperature adjustment system according to the first embodiment;

FIG. 6 is a schematic diagram illustrating a state where a battery strong cooling processing is being performed in the electric motor vehicle temperature adjustment system according to the first embodiment;

FIG. 7 is a schematic diagram illustrating a state where a motor weak cooling processing is being performed in the electric motor vehicle temperature adjustment system according to the first embodiment;

FIG. 8 is a schematic diagram illustrating a state where a motor strong cooling processing is being performed in the electric motor vehicle temperature adjustment system according to the first embodiment;

FIG. 9 is a schematic diagram illustrating an operation state in the low load state of the electric motor vehicle temperature adjustment system according to the first embodiment;

FIG. 10 is a schematic diagram illustrating an operation state in the high load state of the electric motor vehicle temperature adjustment system according to the first embodiment;

FIG. 11 is a flowchart of an electric motor vehicle temperature adjustment processing of the electric motor vehicle temperature adjustment system according to the first embodiment;

FIG. 12 is a flowchart of a temperature adjustment processing at a high temperature of the electric motor vehicle temperature adjustment system according to the first embodiment;

FIG. 13 is a flowchart of a first battery temperature adjustment processing of the electric motor vehicle temperature adjustment system according to the first embodiment;

FIG. 14 is a flowchart of a first refrigerant cooling processing of the electric motor vehicle temperature adjustment system according to the first embodiment;

FIG. 15 is a flowchart of a temperature adjustment processing at a low temperature of the electric motor vehicle temperature adjustment system according to the first embodiment;

FIG. 16 is a flowchart of a second battery temperature adjustment processing of the electric motor vehicle temperature adjustment system according to the first embodiment;

FIG. 17 is a flowchart of a second refrigerant cooling processing of the electric motor vehicle temperature adjustment system according to the first embodiment;

FIG. 18 is a flowchart of a motor temperature adjustment processing of the electric motor vehicle temperature adjustment system according to the first embodiment;

FIG. 19 is a schematic diagram of an electric motor vehicle temperature adjustment system according to another aspect of the first embodiment;

FIG. 20 is a schematic diagram of an electric motor vehicle temperature adjustment system according to a second embodiment;

FIG. 21 is a schematic diagram of an electric motor vehicle temperature adjustment system according to a first modification of the first and second embodiments;

FIG. 22 is a schematic diagram illustrating a state where an electric component waste heat storage processing and a heater warm-up processing are being performed in an electric motor vehicle temperature adjustment system according to a second modification of the first embodiment;

FIG. 23 is a schematic diagram illustrating a state where an electric component waste heat storage processing and a battery heat retention processing are being performed in an electric motor vehicle temperature adjustment system according to a third modification of the first embodiment;

FIG. 24 is a schematic diagram illustrating a state where an electric component heat storage warm-up processing is being performed in an electric motor vehicle temperature adjustment system according to a fourth modification of the first embodiment; and

FIG. 25 is a schematic diagram illustrating a state where a motor is being warmed up in an electric motor vehicle temperature adjustment system according to a fifth modification of the first embodiment.

### DETAILED DESCRIPTION

Hereinafter, embodiments disclosed here will be described with reference to the drawings.

### First Embodiment

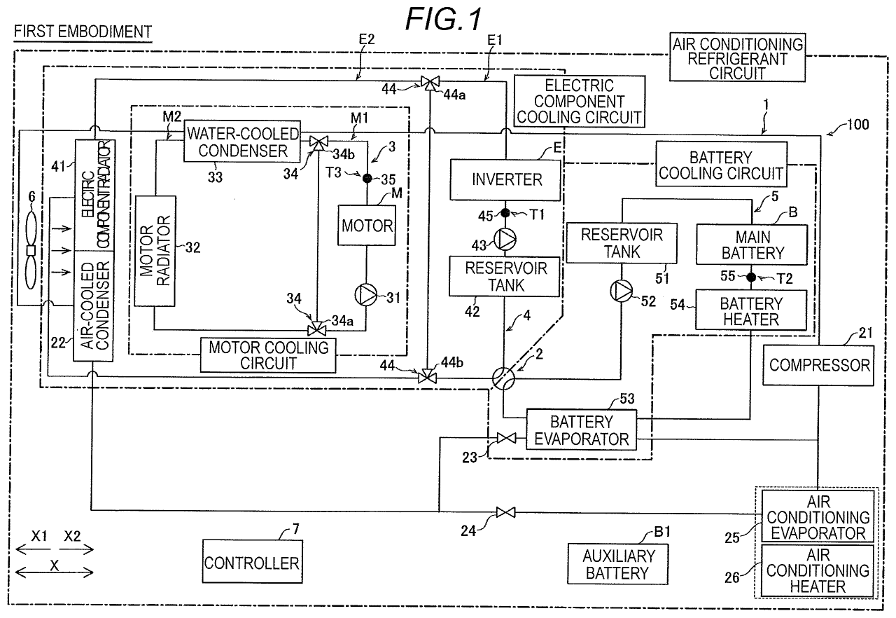

First, a configuration of an electric motor vehicle temperature adjustment system 100 according to a first embodiment will be described with reference to FIGS. 1 to 10. The electric motor vehicle temperature adjustment system 100 is used in an electric vehicle as an electric motor vehicle including a motor (drive motor) M and electric components E and a main battery B for an electric motor vehicle. Here, the electric motor vehicle temperature adjustment system 100 is a system that cools cooling water and a refrigerant for cooling the motor M, the electric components E, and the main battery B. The cooling water and the refrigerant circulate in the electric motor vehicle by the electric motor vehicle temperature adjustment system 100.

The electric motor vehicle temperature adjustment system 100 includes an air conditioning refrigerant circuit 1, a first switching unit 2, a motor cooling circuit 3, an electric component cooling circuit 4, a battery cooling circuit 5, a blower 6, and a controller 7.

The air conditioning refrigerant circuit 1 is configured to flow a refrigerant that cools air-conditioning air. Specifically, the air conditioning refrigerant circuit 1 includes a compressor 21, an air-cooled condenser 22 (an example of “air-cooled condenser” in the claims), a battery expansion valve 23, an air conditioning expansion valve 24, an air conditioning evaporator 25 (an example of “air conditioning evaporator” in the claims), and an air conditioning heater 26.

Here, in the air conditioning refrigerant circuit 1, the refrigerant circulates in the order of the compressor 21, the air-cooled condenser 22, the battery expansion valve 23, and a battery evaporator 53 to be described later (an example of “battery evaporator” in the claims). Further, in the air conditioning refrigerant circuit 1, the refrigerant circulates in the order of the compressor 21, the air-cooled condenser 22, the air conditioning expansion valve 24, and the air conditioning evaporator 25. That is, in the air conditioning refrigerant circuit 1, a flow path is branched at the downstream side of the compressor 21 and the air-cooled condenser 22 so that the refrigerant flows to the battery expansion valve 23 or the air conditioning expansion valve 24.

The compressor 21 is configured to compress the refrigerant. Specifically, the compressor 21 is configured to generate a high-temperature and high-pressure refrigerant vapor by compressing the refrigerant. The air-cooled condenser 22 is configured to condense the refrigerant flowing out of the compressor 21 with outside air. Specifically, the air-cooled condenser 22 is configured to generate a high-pressure refrigerant (supercooled liquid) by exchanging heat between the refrigerant vapor and the outside air. The air-cooled condenser 22 is provided downstream of the compressor 21. Each of the battery expansion valve 23 and the air conditioning expansion valve 24 is configured to generate a low-temperature and low-pressure refrigerant by expanding the high-pressure refrigerant. The battery expansion valve 23 and the air conditioning expansion valve 24 are provided downstream of the air-cooled condenser 22.

The air-conditioning evaporator 25 is configured to cool air (air-conditioning air) in the electric motor vehicle by exchanging heat between the low-temperature and low-pressure refrigerant and the air in the electric motor vehicle to evaporate the low-temperature and low-pressure refrigerant. The air conditioning evaporator 25 is provided downstream of the air conditioning expansion valve 24 and upstream of the compressor 21. The air conditioning heater 26 is configured to perform heating in the electric motor vehicle by heating the air in the electric motor vehicle. Here, the air conditioning evaporator 25 and the air conditioning heater 26 are a part of air conditioning (heating ventilation and air conditioning (HVAC)) equipment of the electric motor vehicle.

### (First Switching Unit)

The first switching unit 2 is configured to perform switching between connection and disconnection of the battery cooling circuit 5 and the electric component cooling circuit 4. Specifically, the first switching unit 2 includes a four-way valve. The first switching unit 2 performs switching between connection and disconnection of an upstream side flow path of the battery evaporator 53 (to be described later) of the air conditioning refrigerant circuit 1 and an upstream side flow path of an electric component radiator 41 of the electric component cooling circuit 4. In this way, the first switching unit 2 performs switching between a connection state of fluidly connecting the battery cooling circuit 5 and the electric component cooling circuit 4 and a disconnection state of interrupting fluid connection between the battery cooling circuit 5 and the electric component cooling circuit 4.

### (Motor Cooling Circuit, Electric Component Cooling Circuit, and Battery Cooling Circuit)

The motor cooling circuit 3, the electric component cooling circuit 4, and the battery cooling circuit 5 of the first embodiment are separated from each other. That is, the battery cooling circuit 5, the electric component cooling circuit 4, and the motor cooling circuit 3 are provided separately. Specifically, the battery cooling circuit 5 and the motor cooling circuit 3 are arranged independently of each other in a state where cooling water does not flow therebetween. Further, the electric component cooling circuit 4 and the motor cooling circuit 3 are arranged independently of each other in a state where cooling water does not flow therebetween.

The battery cooling circuit 5 and the electric component cooling circuit 4 are separated from each other via the first switching unit 2. That is, the battery cooling circuit 5 and the electric component cooling circuit 4 are arranged independently of each other in a state where cooling water does not flow therebetween by setting the first switching unit 2 to the disconnection state. The battery cooling circuit 5 and the electric component cooling circuit 4 are arranged in a state where cooling water flows therebetween by setting the first switching unit 2 to the connection state.

### (Motor Cooling Circuit)

The motor cooling circuit 3 is configured to flow (circulate) cooling water that cools the motor M. Specifically, the motor cooling circuit 3 includes a motor water pump 31, a motor radiator 32, a water-cooled condenser 33 (an example of “water-cooled condenser” in the claims), a second switching unit 34, and a motor temperature sensor 35. Here, the direction in which the motor radiator 32 and the air-cooled condenser 22 are arranged is the X direction (an example of “the longitudinal direction of the vehicle” in the claims), the direction from the motor radiator 32 to the air-cooled condenser 22 is the X1 direction (forward direction), and the direction from the air-cooled condenser 22 to the motor radiator 32 is the X2 direction (rearward direction).

The motor water pump 31 is configured to circulate the cooling water in the motor cooling circuit 3. Specifically, the motor water pump 31 is configured by an electric motor water pump.

The motor radiator 32 is configured to cool the motor M and cool the heated cooling water. Specifically, the motor radiator 32 is a heat radiator that radiates heat of the cooling water to outside air. The water-cooled condenser 33 is configured to cool and condense a refrigerant in advance before flowing into the air-cooled condenser 22. Specifically, the water-cooled condenser 33 is configured to perform heat exchange between the cooling water at the downstream side of the motor radiator 32 in the motor cooling circuit 3 and the refrigerant at the upstream side of the air-cooled condenser 22 in the air conditioning refrigerant circuit 1.

In the motor cooling circuit 3, the second switching unit 34 is configured to perform switching between a motor weak cooling circuit M1 and a motor strong cooling circuit M2. Specifically, the second switching unit 34 has a first motor switching valve 34a and a second motor switching valve 34b. The first motor switching valve 34a and the second motor switching valve 34b are configured by three-way valves. The first motor switching valve 34a is disposed between the motor M and the motor radiator 32. The second motor switching valve 34b is disposed between the water-cooled condenser 33 and the motor M.

The motor temperature sensor 35 is configured to measure the temperature of the cooling water before performing heat exchange with the motor M. The motor temperature sensor 35 is disposed between the water-cooled condenser 33 and the motor M. In addition, the arrangement position of the motor temperature sensor 35 may be other than the position between the water-cooled condenser 33 and the motor M.

The motor weak cooling circuit M1 is a circuit in which the cooling water does not pass through the motor radiator 32 and the water-cooled condenser 33. That is, the motor weak cooling circuit M1 is a circuit that circulates the cooling water without passing through the motor radiator 32 and the water-cooled condenser 33. Specifically, the motor weak cooling circuit M1 is a circuit that flows the cooling water in the order of the motor M, the first motor switching valve 34a, and the second motor switching valve 34b. At this time, the first motor switching valve 34a closes the circuit from the motor M to the motor radiator 32. The second motor switching valve 34b closes the circuit from the motor radiator 32 and the water-cooled condenser 33 to the motor M.

The motor strong cooling circuit M2 is a circuit in which the cooling water passes through the motor radiator 32 and the water-cooled condenser 33. That is, the motor strong cooling circuit M2 is a circuit that circulates the cooling water through the motor radiator 32 and the water-cooled condenser 33. Specifically, the motor strong cooling circuit M2 is a circuit that flows the cooling water in the order of the motor M, the first motor switching valve 34a, the motor radiator 32, the water-cooled condenser 33, and the second motor switching valve 34b. At this time, the first motor switching valve 34a opens the circuit from the motor M to the motor radiator 32. The second motor switching valve 34b opens the circuit from the motor radiator 32 and the water-cooled condenser 33 to the motor M.

### (Electric Component Cooling Circuit)

The electric component cooling circuit 4 is configured to flow (circulate) cooling water that cools the electric components E. Specifically, the electric component cooling circuit 4 includes the electric component radiator 41, a reservoir tank 42, an electric component water pump 43, a third switching unit 44 (an example of “second switching unit” in the claims), and an electric component temperature sensor 45. Here, in the following description, an inverter E among the electric components E will be described by way of example.

The electric component radiator 41 is configured to cool the inverter E and cool the heated cooling water. Specifically, the electric component radiator 41 is a radiator that radiates heat of the cooling water to outside air. The reservoir tank 42 is a gas-liquid separation container that separates air bubbles in the electric component cooling circuit 4 from the cooling water. The electric component water pump 43 is configured to circulate the cooling water in the electric component cooling circuit 4. Specifically, the electric component water pump 43 is configured by an electric motor water pump.

In the electric component cooling circuit 4, the third switching unit 44 is configured to perform switching between an electric component waste heat storage circuit E1 (an example of “first cooling circuit” in the claims) and an electric component cooling circuit E2 (an example of “second cooling circuit” in the claims). Specifically, the third switching unit 44 has a first electric component switching valve 44a and a second electric component switching valve 44b. The first electric component switching valve 44a and the second electric component switching valve 44b are configured by three-way valves. The first electric component switching valve 44a is disposed between the inverter E and the electric component radiator 41. The second electric component switching valve 44b is disposed between the electric component radiator 41 and the reservoir tank 42.

The electric component waste heat storage circuit E1 is a circuit that does not pass the cooling water to the electric component radiator 41. That is, the electric component waste heat storage circuit E1 is a circuit that circulates the cooling water without passing through the electric component radiator 41. Specifically, the electric component waste heat storage circuit E1 is a circuit that flows the cooling water in the order of the inverter E, the first electric component switching valve 44a, the second electric component switching valve 44b, the reservoir tank 42, and the electric component water pump 43. At this time, the first electric component switching valve 44a closes the circuit from the inverter E to the electric component radiator 41. The second electric component switching valve 44b closes the circuit from the electric component radiator 41 to the reservoir tank 42.

The electric component cooling circuit E2 is a circuit in which the cooling water passes through the electric component radiator 41. That is, the electric component cooling circuit E2 is a circuit that circulates the cooling water through the electric component radiator 41. Specifically, the electric component cooling circuit E2 is a circuit that flows the cooling water in the order of the inverter E, the first electric component switching valve 44a, the electric component radiator 41, the second electric component switching valve 44b, the reservoir tank 42, and the electric component water pump 43. At this time, the first electric component switching valve 44a opens the circuit from the inverter E to the electric component radiator 41. The second electric component switching valve 44b opens the circuit from the electric component radiator 41 to the reservoir tank 42.

The electric component temperature sensor 45 is configured to measure the temperature of the cooling water before performing heat exchange with the inverter E. The electric component temperature sensor 45 is disposed between the electric component water pump 43 and the inverter E. In addition, the arrangement position of the electric component temperature sensor 45 may be other than the position between the electric component water pump 43 and the inverter E.

The air-cooled condenser 22 is disposed adjacent to the electric component radiator 41 in the direction orthogonal to the X direction among the horizontal direction. Further, the motor radiator 32 is disposed at the X2 direction side of the air-cooled condenser 22 and the electric component radiator 41.

### (Battery Cooling Circuit)

The battery cooling circuit 5 is configured to flow (circulate) cooling water that cools the main battery B provided separately from an auxiliary battery B1. Here, the auxiliary battery B1 is a battery having a lower voltage than the main battery B, and indicates a battery used in a power supply of a control system that controls a brake and a door lock of the electric motor vehicle. The main battery B is a battery having a higher voltage than the auxiliary battery B1, and indicates a battery that stores electric power for driving a motor (drive motor).

Specifically, the battery cooling circuit 5 includes a reservoir tank 51, a battery water pump 52, the battery evaporator 53 (an example of “battery evaporator” in the claims), a battery heater 54, and a battery temperature sensor 55.

The reservoir tank 51 is a gas-liquid separation container that separates air bubbles in the battery cooling circuit 5 from the cooling water. The battery water pump 52 is configured to circulate the cooling water in the battery cooling circuit 5. Specifically, the battery water pump 52 is configured by an electric motor water pump.

The battery evaporator 53 is configured to cool the cooling water in the battery cooling circuit 5 by exchanging heat between a low-temperature and low-pressure refrigerant and the cooling water in the battery cooling circuit 5 to evaporate the low-temperature and low-pressure refrigerant. That is, the battery evaporator 53 is provided across the air conditioning refrigerant circuit 1 and the battery cooling circuit 5, and is configured to evaporate the refrigerant in the air conditioning refrigerant circuit 1 by heat of the cooling water in the battery cooling circuit 5. The battery evaporator 53 is provided downstream of the battery expansion valve 23 and upstream of the compressor 21.

The battery heater 54 is configured to heat the cooling water in the battery cooling circuit 5. The battery heater 54 is disposed at the upstream side of the main battery B. Specifically, the battery heater 54 is disposed between the battery temperature sensor 55 and the battery evaporator 53.

The battery temperature sensor 55 is configured to measure the temperature of the cooling water before performing heat exchange with the main battery B. The battery temperature sensor 55 is disposed between the main battery B and the battery heater 54. In addition, the arrangement position of the battery temperature sensor 55 may be other than the position between the main battery B and the battery heater 54.

The battery cooling circuit 5 is a circuit in which the cooling water passes through the battery evaporator 53. That is, the battery cooling circuit 5 is a circuit that flows the cooling water in the order of the reservoir tank 51, the battery water pump 52, the battery evaporator 53, the battery heater 54, the battery temperature sensor 55, and the main battery B.

The blower 6 is configured to send air to and cool the air-cooled condenser 22, the motor radiator 32, and the electric component radiator 41. Here, the blower 6 is configured to blow air to the air-cooled condenser 22, the motor radiator 32, and the electric component radiator 41 by rotating a fan by a drive source such as a motor. In addition, the blower 6 may be configured to blow air to the air-cooled condenser 22, the motor radiator 32, and the electric component radiator 41 by rotating the fan by vehicle-speed air in a state where the drive source is stopped.

In this way, the blower 6 is configured to cool the refrigerant flowing in the air-cooled condenser 22, the cooling water flowing in the motor radiator 32, and the cooling water flowing in the electric component radiator 41 by sending air to and cool the air-cooled condenser 22, the motor radiator 32, and the electric component radiator 41. In addition, when the blower 6 stops an operation, cooling of the refrigerant flowing in the air-cooled condenser 22, the cooling water flowing in the motor radiator 32, and the cooling water flowing in the electric component radiator 41 by the blower 6 is stopped.

### (Controller)

The controller 7 is configured to control the temperatures of the motor M, the inverter E, and the main battery B based on the temperature T3 of the motor temperature sensor 35 of the motor cooling circuit 3, the temperature T1 of the electric component temperature sensor 45 of the electric component cooling circuit 4, and the temperature T2 of the battery temperature sensor 55 of the battery cooling circuit 5. Here, a desired target temperature of the motor M is about 20° C. or more and about 80° C. or less. A desired target temperature of the inverter E is about 20° C. or more and about 60° C. or less. A desired target temperature of the main battery B is about 20° C. or more and about 40° C. or less.

The controller 7 includes a central processing unit (CPU) (not illustrated) as a control circuit and a memory (not illustrated) as a storage medium. The controller 7 controls each unit of the electric motor vehicle by causing the CPU to execute a control program stored in the memory.

The control program has a temperature adjustment processing including an electric component waste heat storage processing, a heater warm-up processing, a battery heat retention processing, an electric component heat storage warm-up processing, a battery weak cooling processing, and a battery strong cooling processing. The controller 7 is configured to separately control the temperatures of the motor M, the inverter E, and the main battery B according to the control program.

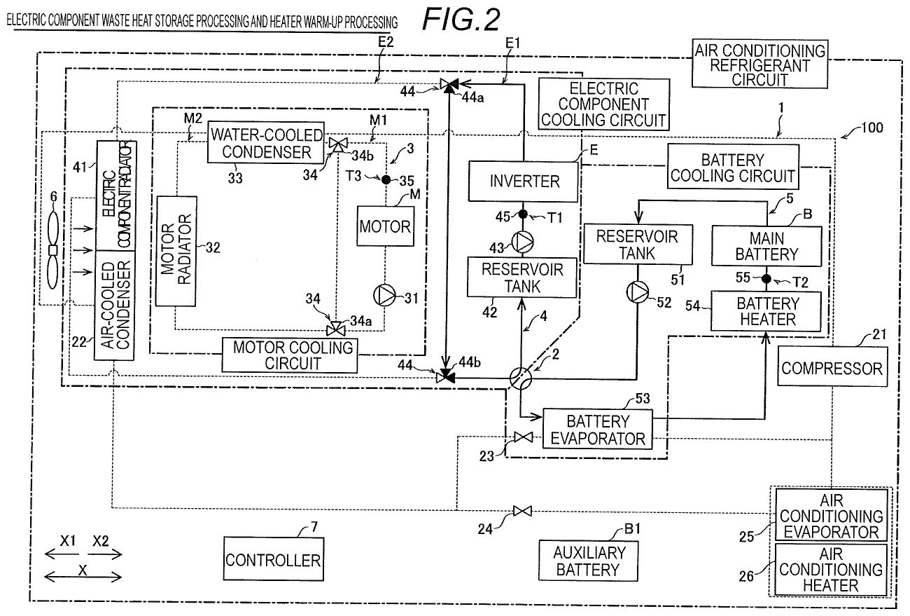

As illustrated in FIG. 2, the controller 7 is configured to perform both the electric component waste heat storage processing and the heater warm-up processing based on the temperature T1 of the electric component temperature sensor 45 of the electric component cooling circuit 4 and the temperature T2 of the battery temperature sensor 55 of the battery cooling circuit 5. In the heater warm-up processing, the outside air temperature is in a first predetermined range (more than −30° C. and less than 35° C.). In addition, in FIG. 2, the circuits in which the cooling water or the refrigerant flows are indicated by solid lines and the other circuits are indicated by broken lines.

Specifically, the controller 7 is configured to perform the heater warm-up processing based on the facts that the temperature T1 of the electric component temperature sensor 45 of the electric component cooling circuit 4 is less than the temperature T2 of the battery temperature sensor 55 of the battery cooling circuit 5, and that the temperature T2 of the battery temperature sensor 55 of the battery cooling circuit 5 is less than a first predetermined temperature (about 10° C.). That is, the controller 7 is configured to perform control to warm the main battery B by the cooling water heated by the battery heater 54 in a state where the battery cooling circuit 5 and the electric component cooling circuit 4 are disconnected by the first switching unit 2. At this time, the controller 7 is configured to perform control to switch whether to continuously circulate or intermittently circulate the cooling water by the battery water pump 52. Here, in the heater warm-up processing, the target water temperature of the battery cooling circuit 5 is 10° C.

Further, the controller 7 is configured to perform the electric component waste heat storage processing. That is, the controller 7 is configured to perform control to switch from the electric component cooling circuit 4 to the electric component waste heat storage circuit E1 by the third switching unit 44 and at the same time, to circulate the cooling water in the electric component waste heat storage circuit E1 and store heat of the inverter E in the cooling water. At this time, the controller 7 is configured to perform control to continuously circulate the cooling water by the electric component water pump 43. Further, the controller 7 is configured to perform control to stop the compressor 21 and stop cooling by the air conditioning evaporator 25 and the battery evaporator 53. In addition, the controller 7 is configured to perform control to close the battery expansion valve 23 and open the air conditioning expansion valve 24 and at the same time, to operate the compressor 21 and start cooling by the air conditioning evaporator 25 when an instruction of starting an air conditioning operation is made by a user operation in a vehicle room.

The above processings are summarized as illustrated in Table 1 below.

TABLE 1

| | | Device | | | State of First |
|---|---|---|---|---|---|
| | Object | Water Pump | Compressor | Battery Heater | Switching Unit |
| Electric Component | Inverter Waste | Operation | | | Disconnection |
| Cooling Circuit | Heat Storage | | | | State |
| Battery Cooling Circuit | Battery Warm- | Operation/— | | Operating | Disconnection |
| | up | Intermittent | | (Target Water | State |
| | | Operation | | Temperature: | |
| | | | | 10° C.) | |
| Air Conditioning | | | | | |
| Refrigerant Circuit | | | | | |
| Battery Evaporator Side | | | Stop | | |
| | | | (Operation) | | |
| Air Conditioning | | | Stop | | |
| Evaporator Side | | | (Operation) | | |

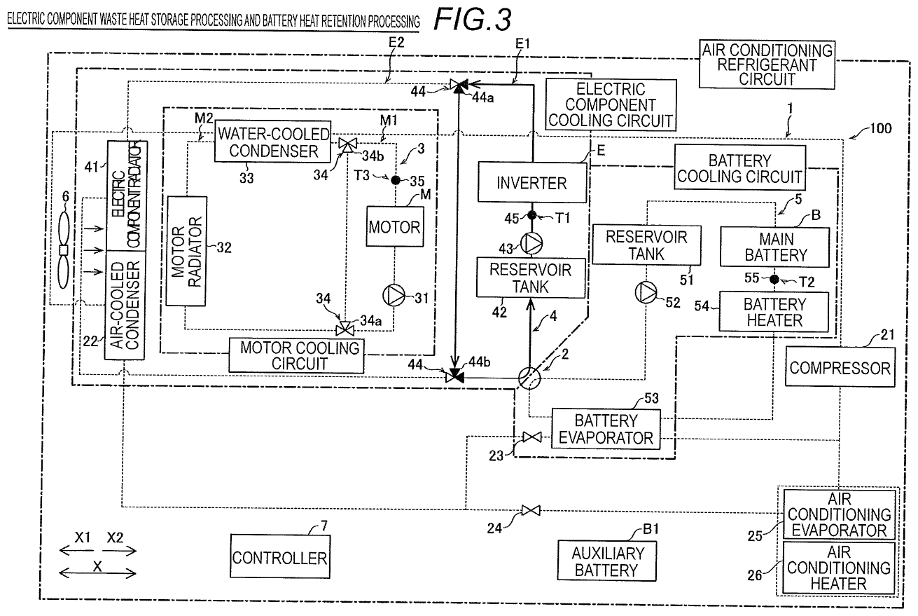

As illustrated in FIG. 3, the controller 7 is configured to perform both the electric component waste heat storage processing and the battery heat retention processing based on the temperature T1 of the electric component temperature sensor 45 of the electric component cooling circuit 4 and the temperature T2 of the battery temperature sensor 55 of the battery cooling circuit 5. In the battery heat retention processing, the outside air temperature is in the first predetermined range (more than −30° C. and less than 35° C.). In addition, in FIG. 3, the circuits in which the cooling water or the refrigerant flows are indicated by solid lines and the other circuits are indicated by a broken line.

Specifically, the controller 7 is configured to perform the battery heat retention processing based on the fact that the temperature T2 of the battery temperature sensor 55 of the battery cooling circuit 5 is equal to or more than the first predetermined temperature (about 10° C.) and less than a second predetermined temperature (about 35° C.). That is, the controller 7 is configured to perform only control to determine whether to stop circulation of the cooling water or intermittently circulate the cooling water by the battery water pump 52 in a state where the battery cooling circuit 5 and the electric component cooling circuit 4 are disconnected by the first switching unit 2. Further, the controller 7 is configured to perform control to stop the compressor 21 and stop cooling by the air conditioning evaporator 25 and the battery evaporator 53. In addition, the controller 7 is configured to perform control to close the battery expansion valve 23 and open the air conditioning expansion valve 24 and at the same time, to operate the compressor 21 and start cooling by the air conditioning evaporator 25 when an instruction of starting an air conditioning operation is made by a user operation in the vehicle room.

Further, the controller 7 is configured to perform the electric component waste heat storage processing similar to that in FIG. 2. The above processings are summarized as illustrated in Table 2 below.

TABLE 2

| | Device | | | State of First |
|---|---|---|---|---|
| Object | Water Pump | Compressor | Battery Heater | Switching Unit |

| | | | | |
|---|---|---|---|---|
| Electric Component | Inverter Waste | Operation | | Disconnection |
| Cooling Circuit | Heat Storage | | | State |
| Battery Cooling Circuit | Battery Heat | Stop/— | | Disconnection |
| | Retention | Intermittent | | State |
| | | Operation | | |
| Air Conditioning | | | | |
| Refrigerant Circuit | | | | |
| Battery Evaporator Side | | | Stop | |
| | | | (Operation) | |
| Air Conditioning | | | Stop | |
| Evaporator Side | | | (Operation) | |

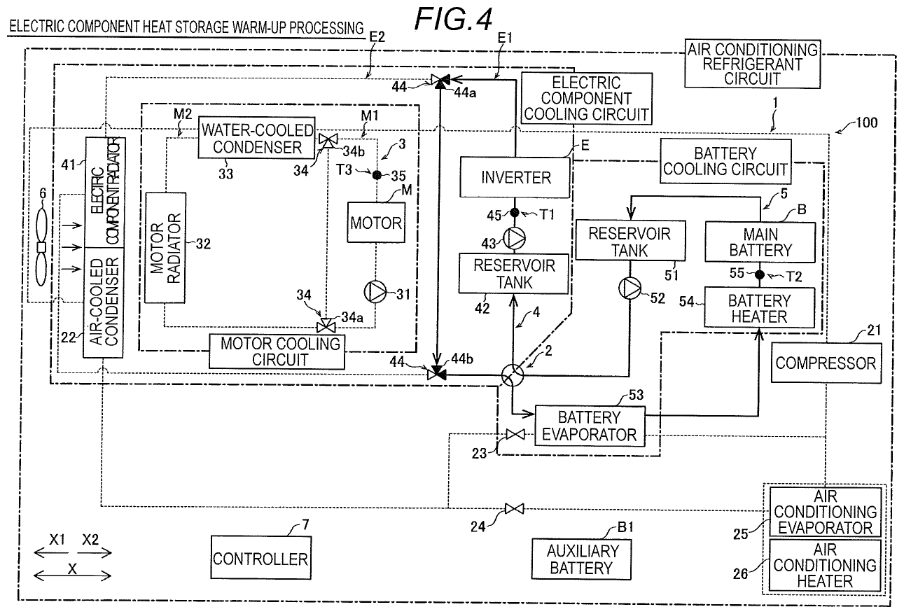

As illustrated in FIG. 4, the controller 7 is configured to perform the electric component heat storage warm-up processing based on the temperature T1 of the electric component temperature sensor 45 of the electric component cooling circuit 4 and the temperature T2 of the battery temperature sensor 55 of the battery cooling circuit 5. In the electric component heat storage warm-up processing, the outside air temperature is in the first predetermined range (more than −30° C. and less than 35° C.). In addition, in FIG. 4, the circuits in which the cooling water or the refrigerant flows are indicated by solid lines and the other circuits are indicated by broken lines.

Specifically, the controller 7 is configured to perform the electric component heat storage warm-up processing based on the facts that the temperature T1 of the electric component temperature sensor 45 of the electric component cooling circuit 4 is less than the first predetermined temperature (about 10° C.), that the temperature T2 of the battery temperature sensor 55 of the battery cooling circuit 5 is less than the first predetermined temperature (about 10° C.), and that the temperature T1 of the electric component temperature sensor 45 of the electric component cooling circuit 4 is more than the temperature T2 of the battery temperature sensor 55 of the battery cooling circuit 5. That is, the controller 7 is configured to perform control to warm the main battery B by supplying the cooling water of the electric component waste heat storage circuit E1 storing heat of the inverter E in a state where the battery cooling circuit 5 and the electric component cooling circuit 4 are connected by the first switching unit 2. In this way, in the electric motor vehicle temperature adjustment system 100, the electric component cooling circuit 4 is configured so as to be switched, by the third switching unit 44, to the electric component waste heat storage circuit E1 that does not pass through the electric component radiator 41 when the electric component cooling circuit 4 and the battery cooling circuit 5 are switched by the first switching unit 2 so as to be connected to each other.

At this time, the controller 7 is configured to perform control to switch whether to continuously circulate or intermittently circulate the cooling water by the battery water pump 52. Further, the controller 7 is configured to perform control to stop the circulation of the cooling water by the electric component water pump 43. Further, the controller 7 is configured to perform control to stop the compressor 21 and stop cooling by the air conditioning evaporator 25 and the battery evaporator 53. In addition, the controller 7 is configured to perform control to close the battery expansion valve 23 and open the air conditioning expansion valve 24 and at the same time, to operate the compressor 21 and start cooling by the air conditioning evaporator 25 when an instruction of starting an air conditioning operation is made by a user operation in the vehicle room.

The above processings are summarized as illustrated in Table 3 below.

TABLE 3

| | Device | | | State of First |
|---|---|---|---|---|
| Object | Water Pump | Compressor | Battery Heater | Switching Unit |

| | | | | |
|---|---|---|---|---|
| Electric Component | Battery Warm- | Stop | | Connection |
| Cooling Circuit | up | | | State |
| Battery Cooling Circuit | Battery Warm- | Operation/— | | Connection |
| | up | Intermittent | | State |
| | | Operation | | |
| Air Conditioning | | | | |
| Refrigerant Circuit | | | | |
| Battery Evaporator Side | | | Stop | |
| | | | (Operation) | |
| Air Conditioning | | | Stop | |
| Evaporator Side | | | (Operation) | |

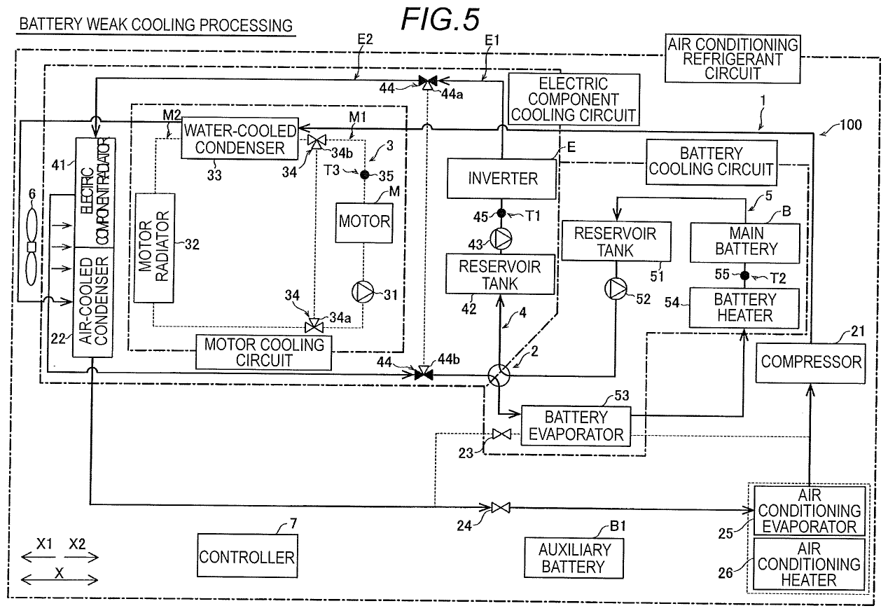

As illustrated in FIG. 5, the controller 7 is configure to perform the battery weak cooling processing based on the temperature T1 of the electric component temperature sensor 45 of the electric component cooling circuit 4 and the temperature T2 of the battery temperature sensor 55 of the battery cooling circuit 5. The battery weak cooling processing changes based on whether the outside air temperature is in the first predetermined range (more than −30° C. and less than 35° C.) or whether the outside air temperature is in a second predetermined range (more than 35° C. and less than 40° C.). In addition, in FIG. 5, the circuits in which the cooling water or the refrigerant flows are indicated by solid lines and the other circuits are indicated by broken lines.

Specifically, when the outside air temperature is in the first predetermined range, the controller 7 is configured to perform the battery weak cooling processing based on the facts that the temperature T2 of the battery temperature sensor 55 of the battery cooling circuit 5 is the first predetermined range (more than −30° C. and less than 35° C.), and that the temperature T1 of the electric component temperature sensor 45 of the electric component cooling circuit 4 is less than the temperature T2 of the battery temperature sensor 55 of the battery cooling circuit 5. That is, the controller 7 is configured to perform control to cool the main battery B by supplying the cooling water in the battery cooling circuit 5 to the electric component radiator 41 through the electric component cooling circuit E2 to cool the electric component radiator 41 in a state where the battery cooling circuit 5 and the electric component cooling circuit 4 are connected by the first switching unit 2. In this way, in the electric motor vehicle temperature adjustment system 100, the electric component cooling circuit 4 is configured so as to be switched by the third switching unit 44 to the electric component cooling circuit E2 that passes through the electric component radiator 41 when the electric component cooling circuit 4 and the battery cooling circuit 5 are switched by the first switching unit 2 so as to be connected to each other.

At this time, the controller 7 is configured to perform control to switch whether to continuously circulate or intermittently circulate the cooling water by the battery water pump 52. Further, the controller 7 is configured to perform control to stop the circulation of the cooling water by the electric component water pump 43. Further, the controller 7 is configured to perform control to operate the compressor 21 and perform cooling by the air conditioning evaporator 25 and at the same time, to stop cooling by the battery evaporator 53. That is, the controller 7 is configured to perform control to close the battery expansion valve 23 and open the air conditioning expansion valve 24 and at the same time, to operate the compressor 21 and start cooling by the air conditioning evaporator 25.

Further, when the outside air temperature is in the second predetermined range (more than 35° C. and less than 40° C.), the controller 7 is configured to perform the battery weak cooling processing based on the facts that the temperature T2 of the battery temperature sensor 55 of the battery cooling circuit 5 is in a third predetermined range (less than 40° C.), and that the temperature T1 of the electric component temperature sensor 45 of the electric component cooling circuit 4 is less than the temperature T2 of the battery temperature sensor 55 of the battery cooling circuit 5. The battery weak cooling processing is similar to that when the outside air temperature is in the first predetermined range.

Further, in the battery weak cooling processing, the controller 7 may be configured to exchange heat between a low-temperature and low-pressure refrigerant and air in the electric motor vehicle by the air conditioning evaporator 25 to cool the air in the electric motor vehicle.

The above processings are summarized as illustrated in Table 4 below.

TABLE 4

| | Device | | | State of First |
|---|---|---|---|---|
| Object | Water Pump | Compressor | Battery Heater | Switching Unit |

| | | | | |
|---|---|---|---|---|
| Electric Component | Inverter Weak | Stop | | Connection |
| Cooling Circuit | Cooling | | | State |
| Battery Cooling Circuit | Battery Weak | Operation/— | | Connection |
| | Cooling | Intermittent | | State |
| | | Operation | | |
| Air Conditioning | | | | |
| Refrigerant Circuit | | | | |
| Battery Evaporator Side | | | Operation | |
| Air Conditioning | | | Operation | |
| Evaporator Side | | | | |

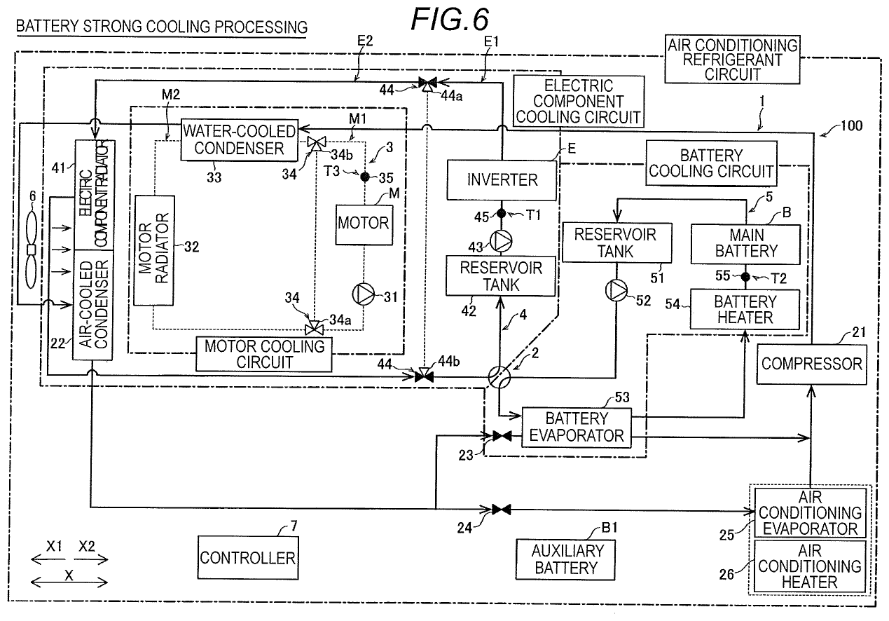

As illustrated in FIG. 6, the controller 7 is configured to perform the battery strong cooling processing based on the temperature T2 of the battery temperature sensor 55 of the battery cooling circuit 5. The battery strong cooling processing is performed based on whether the outside air temperature is in the first predetermined range (more than −30° C. and less than 35° C.), whether the outside air temperature is in the second predetermined range (more than 35° C. and less than 40° C.), or whether the outside air temperature is in a fourth predetermined range (more than 40° C.). In addition, in FIG. 6, the circuits in which the cooling water or the refrigerant flows are indicated by solid lines and the other circuits are indicated by broken lines.

Specifically, when the outside air temperature is in the first predetermined range (more than −30° C. and less than 35° C.), the controller 7 is configured to perform the battery strong cooling processing based on the fact that the temperature T2 of the battery temperature sensor 55 of the battery cooling circuit 5 is in the fourth predetermined range (more than 40° C.).

That is, when the outside air temperature is in the first predetermined range (more than −30° C. and less than 35° C.), the controller 7 is configured to perform control to cool the main battery B by cooling the cooling water in the battery cooling circuit 5 by the battery evaporator 53 in a state where the battery cooling circuit 5 and the electric component cooling circuit 4 are disconnected by the first switching unit 2. At this time, the controller 7 is configured to perform control to switch whether to continuously circulate or intermittently circulate the cooling water by the battery water pump 52.

Further, when the outside air temperature is in the first predetermined range (more than −30° C. and less than 35° C.), the controller 7 is configured to perform control to cool the inverter E by cooling the cooling water in the electric component cooling circuit 4 by the electric component radiator 41 in a state where the battery cooling circuit 5 and the electric component cooling circuit 4 are disconnected by the first switching unit 2. At this time, the controller 7 is configured to perform control to continuously circulate the cooling water by the electric component water pump 43.

When the outside air temperature is in the second predetermined range (more than 35° C. and less than 40° C.) or in the fourth predetermined range (more than 40° C.), the controller 7 is also configured to perform the battery strong cooling processing similar to that when the outside air temperature is in the first predetermined range (more than −30° C. and less than 35° C.).

Further, in the battery strong cooling processing, the controller 7 may be configured to exchange heat between a low-temperature and low-pressure refrigerant and air in the electric motor vehicle by the air conditioning evaporator 25 to cool the air in the electric motor vehicle.

The above processings are summarized as illustrated in Table 5 below.

TABLE 5

| | Device | | | State of First |
|---|---|---|---|---|
| Object | Water Pump | Compressor | Battery Heater | Switching Unit |

| | | | | |
|---|---|---|---|---|
| Electric Component | Inverter Strong | Operation | | Disconnection |
| Cooling Circuit | Cooling | | | State |
| Battery Cooling Circuit | Battery Strong | Operation/— | | Disconnection |
| | Cooling | Intermittent | | State |
| | | Operation | | |
| Air Conditioning | | | | |
| Refrigerant Circuit | | | | |
| Battery Evaporator Side | Battery Strong | | Operation | |
| | Cooling | | | |
| Air Conditioning | | | Operation | |
| Evaporator Side | | | | |

As described above, the electric motor vehicle temperature adjustment system 100 is configured to switch, by the first switching unit 2, whether to operate the compressor 21 and cool the cooling water flowing through the battery cooling circuit 5 by the battery evaporator 53 or to cool the cooling water by the electric component radiator 41 based on the temperatures of both the main battery B and the inverter E.

The temperature adjustment processing includes a motor weak cooling processing and a motor strong cooling processing.

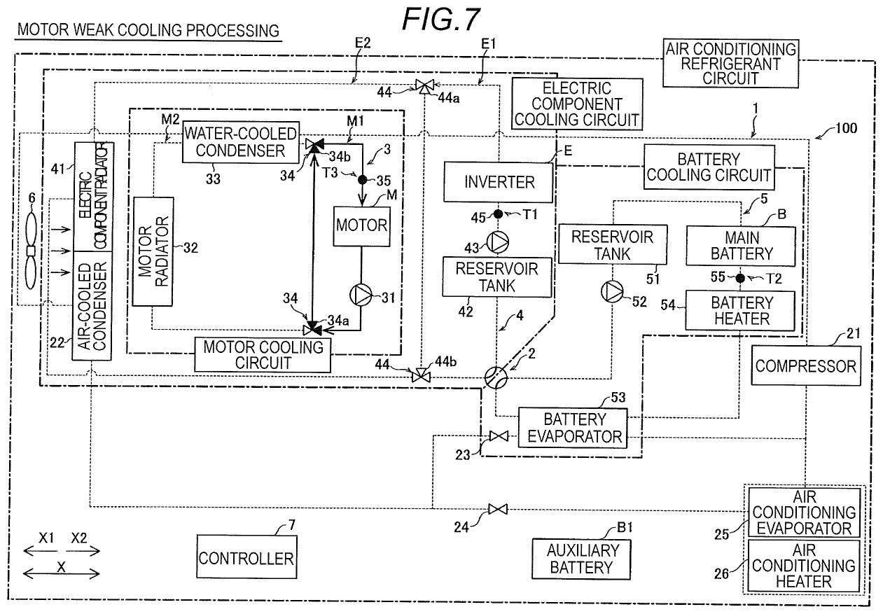

As illustrated in FIG. 7, the controller 7 is configured to perform the motor weak cooling processing based on the temperature T3 of the motor temperature sensor 35 of the motor cooling circuit 3. In the motor weak cooling processing, the temperature of the motor temperature sensor 35 of the motor cooling circuit 3 is less than a threshold value (65° C.). In addition, in FIG. 7, the circuits in which the cooling water or the refrigerant flows are indicated by solid lines and the other circuits are indicated by broken lines.

That is, the controller 7 is configured to perform switching, by the second switching unit 34, from the motor cooling circuit 3 to the motor weak cooling circuit M1 based on the fact that the temperature of the motor temperature sensor 35 of the motor cooling circuit 3 is less than the threshold value (65° C.). At this time, the controller 7 is configured to perform control to switch whether to continuously circulate or intermittently circulate the cooling water by the motor water pump 31.

The above processing is summarized as illustrated in Table 6 below.

TABLE 6

| | Device | | | State of First |
|---|---|---|---|---|
| Object | Water Pump | Compressor | Battery Heater | Switching Unit |

| | | |
|---|---|---|
| Motor Cooling | Motor Weak | Operation/— |
| Circuit | Cooling | Intermittent |
| | | Operation |

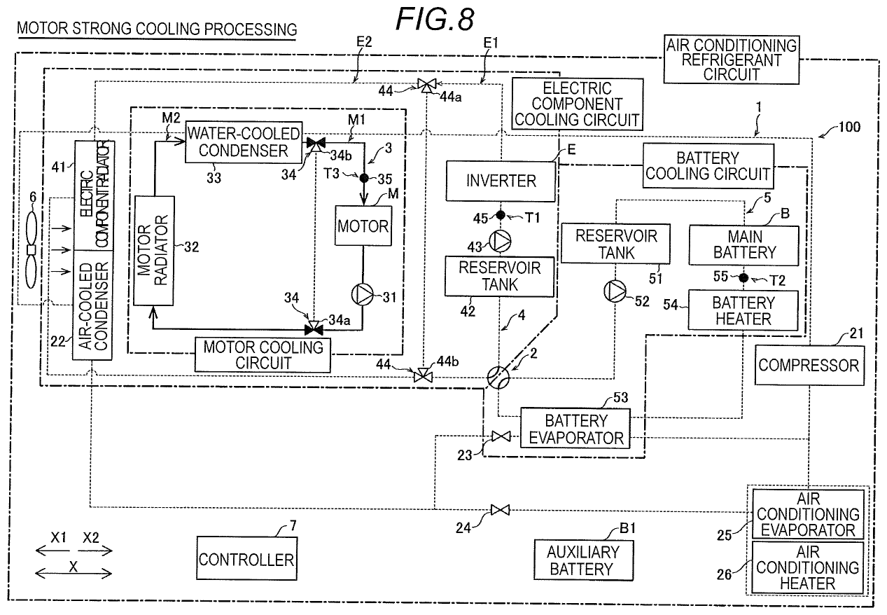

As illustrated in FIG. 8, the controller 7 is configured to perform the motor strong cooling processing based on the temperature T3 of the motor temperature sensor 35 of the motor cooling circuit 3. In the motor strong cooling processing, the temperature of the motor temperature sensor 35 of the motor cooling circuit 3 is equal to or more than the threshold value (65° C.). In addition, in FIG. 8, the circuits in which the cooling water or the refrigerant flows are indicated by solid lines and the other circuits are indicated by broken lines.

That is, the controller 7 is configured to perform switching, by the second switching unit 34, from the motor cooling circuit 3 to the motor strong cooling circuit M2 based on the fact that the temperature of the motor temperature sensor 35 of the motor cooling circuit 3 is equal to or more than the threshold value (65° C.). The controller 7 is configured to cool the cooling water in the motor strong cooling circuit M2 by the motor radiator 32. At this time, the controller 7 is configured to perform control to switch to continuously circulate or intermittently circulate the cooling water by the motor water pump 31.

The above processing is summarized as illustrated in Table 7 below.

TABLE 7

| | Device | | | State of First |
|---|---|---|---|---|
| Object | Water Pump | Compressor | Battery Heater | Switching Unit |

| | | |
|---|---|---|
| Motor Cooling | Motor Strong | Operation/— |
| Circuit | Cooling | Intermittent |
| | | Operation |

Next, an exemplary state of the electric motor vehicle temperature adjustment system 100 when load on the motor M is in a low load state or in a high load state upon vehicle traveling will be described.

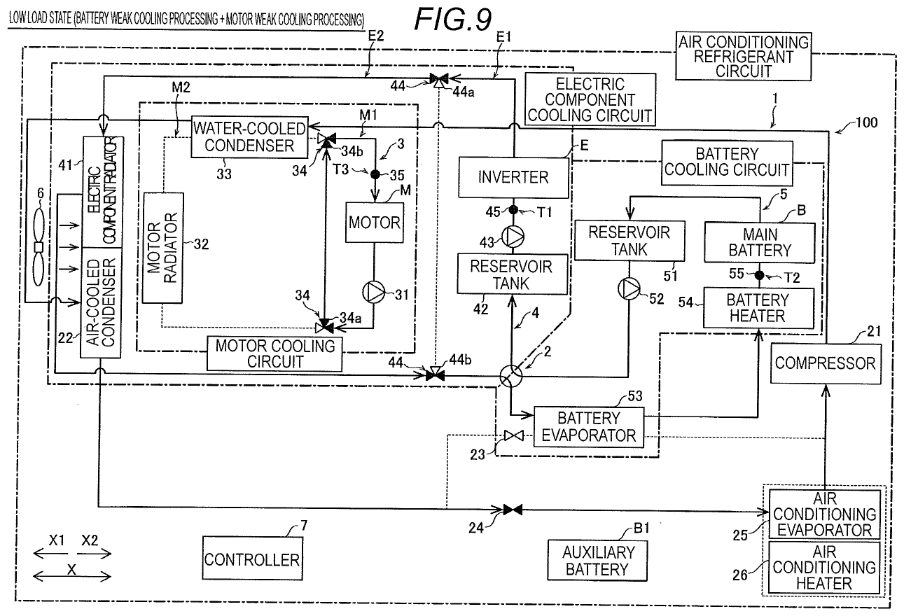

First, a case where load on the motor M is in a low load state upon vehicle traveling will be described with reference to FIG. 9. Here, the state where load on the motor M is in a low load state upon vehicle traveling illustrates an exemplary state where the temperature of the motor temperature sensor 35 of the motor cooling circuit 3 is less than the threshold value (65° C.), the temperature T1 of the electric component temperature sensor 45 of the electric component cooling circuit 4 is less than the temperature T2 of the battery temperature sensor 55 of the battery cooling circuit 5, and the temperature T2 of the battery temperature sensor 55 of the battery cooling circuit 5 is in the first predetermined range (more than −30° C. and less than 35° C.) or in the second predetermined range (more than 35° C. and less than 40° C.).

When load on the motor M is in a low load state upon vehicle traveling, for example, the controller 7 may be configured to perform control to perform the battery weak cooling processing and the motor weak cooling processing in parallel. In addition, in FIG. 9, the circuits in which the cooling water or the refrigerant flows are indicated by solid lines and the other circuits are indicated by broken lines.

The controller 7 is configured to perform control to cool the main battery B and the inverter E by supplying the cooling water in the battery cooling circuit 5 to the electric component radiator 41 through the electric component cooling circuit E2 in a state where the battery cooling circuit 5 and the electric component cooling circuit 4 are connected by the first switching unit 2. In addition, the controller 7 is configured to switch whether to continuously circulate or intermittently circulate the cooling water by the motor water pump 31 and circulate the cooling water in the motor weak cooling circuit M1.

Further, the controller 7 is configured to perform control to operate the compressor 21 and perform cooling by the air conditioning evaporator 25 and at the same time, to stop cooling by the battery evaporator 53. That is, the controller 7 is configured to perform control to close the battery expansion valve 23 and open the air conditioning expansion valve 24 and at the same time, to operate the compressor 21 and start cooling by the air conditioning evaporator 25.

When load on the motor M is in a low load state upon vehicle traveling, the water-cooled condenser 33 stops pre-cooling of the refrigerant before flowing into the air-cooled condenser 22 by the cooling water flowing through the motor cooling circuit 3. In addition, even in a state where load on the motor M is in a low load state upon vehicle traveling, the refrigerant before flowing into the air-cooled condenser 22 may be pre-cooled with the cooling water flowing through the motor cooling circuit 3 by the water-cooled condenser 33. The above processings are summarized as illustrated in Table 8 below.

TABLE 8

| | Device | | | State of First |
|---|---|---|---|---|
| Object | Water Pump | Compressor | Battery Heater | Switching Unit |

| | | | | |
|---|---|---|---|---|
| Electric Component | Electric | Stop | | Connection |
| Cooling Circuit | Component | | | State |
| | Weak Cooling | | | |
| Motor Cooling Circuit | Motor Weak | Operation/— | | |
| | Cooling | Intermittent | | |
| | | Operation | | |
| Battery Cooling Circuit | Battery Weak | Stop/— | | Connection |
| | Cooling | Intermittent | | State |
| | | Operation | | |
| Air Conditioning | Air Cooling | | | |
| Refrigerant Circuit | Circulation | | | |
| Battery Evaporator Side | | | Operation | |
| Air Conditioning | Cooling | | Operation | |
| Evaporator Side | | | | |

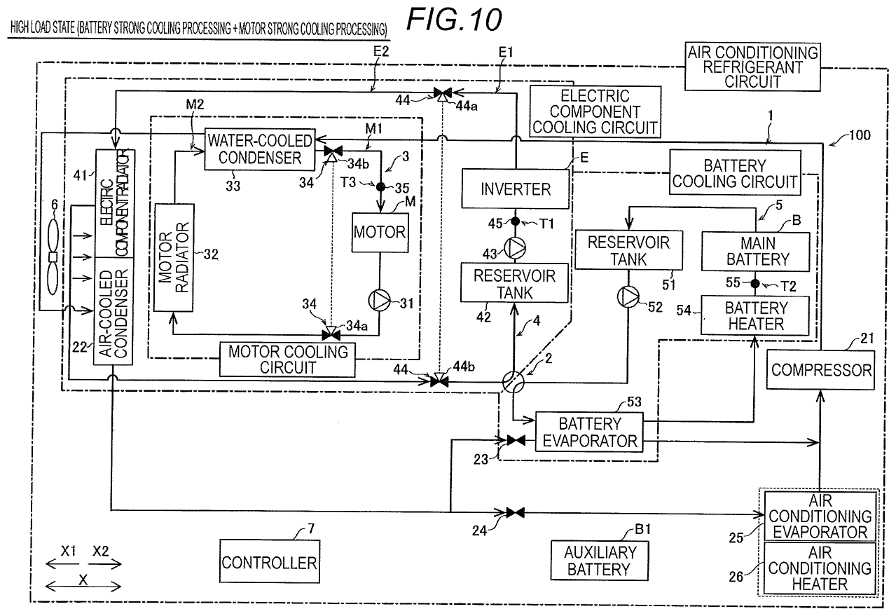

Next, a case where load on the motor M is in a high load state upon vehicle traveling will be described with reference to FIG. 10. Here, a state where load on the motor M is in a high load state upon vehicle traveling illustrates an exemplary state where the temperature of the motor temperature sensor 35 of the motor cooling circuit 3 is equal to or more than the threshold value (65° C.) and the temperature T2 of the temperature sensor 55 of the battery cooling circuit 5 is in the fourth predetermined range (more than 40° C.).

When load on the motor M is in a high load state upon vehicle traveling, for example, the controller 7 may be configured to perform control to perform the battery strong cooling processing and the motor strong cooling processing in parallel. In addition, in FIG. 10, the circuits in which the cooling water or the refrigerant flows are indicated by solid lines and the other circuits are indicated by broken lines.

The controller 7 is configured to perform control to cool the main battery B by cooling the cooling water in the battery cooling circuit 5 by the battery evaporator 53 when the temperature T2 of the battery temperature sensor 55 of the battery cooling circuit 5 is in the fourth predetermined range (more than 40° C.). Further, the controller 7 is configured to perform control to cool the motor M by cooling the cooling water in the motor strong cooling circuit M2 by the motor radiator 32.

Further, the controller 7 is configured to perform control to operate the compressor 21 and perform cooling by the air conditioning evaporator 25 and at the same time, to perform cooling by the battery evaporator 53.

In this case, in the water-cooled condenser 33, the refrigerant before flowing into the air-cooled condenser 22 is pre-cooled by the cooling water flowing through the motor cooling circuit 3. The above processings are summarized as illustrated in Table 9 below.

TABLE 9

| | Device | | | State of First |
|---|---|---|---|---|
| Object | Water Pump | Compressor | Battery Heater | Switching Unit |

| | | | | |
|---|---|---|---|---|
| Electric Component | Electric | Operation | | Disconnection |
| Cooling Circuit | Component | | | State |
| | Strong Cooling | | | |
| Motor Cooling Circuit | Motor Strong | Operation/— | | |
| | Cooling | Intermittent | | |
| | | Operation | | |
| Battery Cooling Circuit | Battery Strong | Operation/— | | Disconnection |
| | Cooling | Intermittent | | State |
| | | Operation | | |
| Air Conditioning | Water- | | | |
| Refrigerant Circuit | Cooling/Air- | | | |
| | Cooling | | | |
| | Circulation | | | |
| Battery Evaporator Side | Battery Strong | | Operation | |
| | Cooling | | | |
| Air Conditioning | Cooling | | Operation | |
| Evaporator Side | | | | |

### (Flow of Temperature Adjustment Processing)

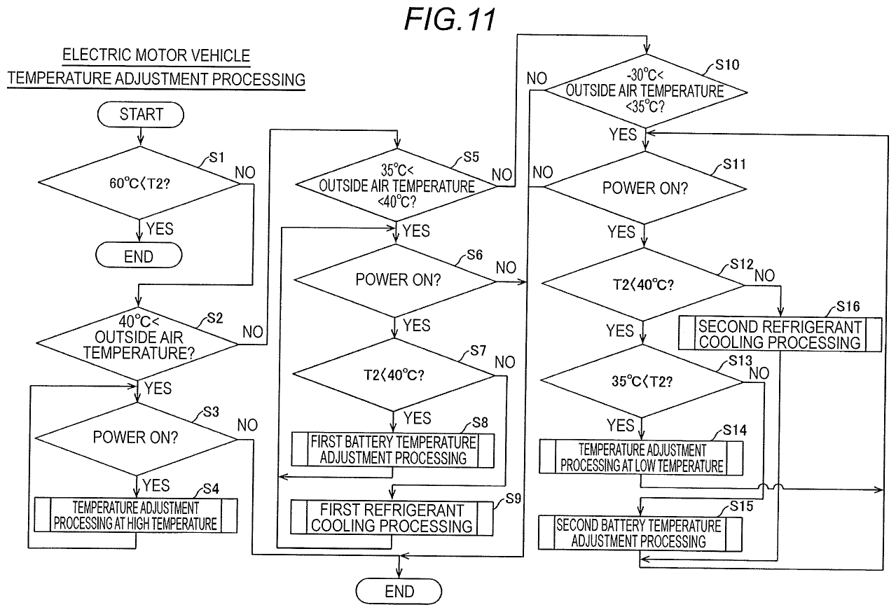

Hereinafter, a temperature adjustment processing will be described with reference to FIGS. 11 to 17. The temperature adjustment processing is a processing of managing the temperatures of the motor cooling circuit 3, the electric component cooling circuit 4, and the battery cooling circuit 5.

First, main steps S1 to S16 illustrating a temperature adjustment processing of the cooling water of the battery cooling circuit 5 according to the outside air temperature will be described with reference to FIG. 11.

In step S1, it is determined whether or not the temperature T2 of the cooling water of the battery cooling circuit 5 is more than 60° C. When the temperature T2 of the cooling water of the battery cooling circuit 5 is more than 60° C., the temperature adjustment processing is immediately terminated. When the temperature T2 of the cooling water of the battery cooling circuit 5 is 60° C. or less, the processing proceeds to step S2. In addition, since the main battery B is not in operation when the temperature T2 of the cooling water of the battery cooling circuit 5 is more than 60° C., a processing of not starting the electric motor vehicle may be performed instead of immediately terminating the temperature adjustment processing.

In step S2, it is determined whether or not the outside air temperature is more than 40° C. When the outside air temperature is more than 40° C., the processing proceeds to step S3. When the outside air temperature is 40° C. or less, the processing proceeds to step S5. In step S3, it is determined whether or not the power is on. When the power is on, the processing proceeds to step S4. When the power is not on, the temperature adjustment processing is terminated. In addition, “the power” indicates a switch pressed by a user to start the electric motor vehicle.

In step S4, a temperature adjustment processing at a high temperature is performed. The temperature adjustment processing at a high temperature is a processing including a battery strong cooling processing. After termination of step S4, the processing returns to step S3.

In step S5, it is determined whether or not the outside air temperature is more than 35° C. and less than 40° C. When the outside air temperature is more than 35° C. and less than 40° C., the processing proceeds to step S6. When the outside air temperature is not in the range from 35° C. to 40° C., the processing proceeds to step 10. In step S6, it is determined whether or not the power is on. When the power is on, the processing proceeds to step S7. When the power is not on, the temperature adjustment processing is terminated.

In step S7, it is determined whether or not the temperature T2 of the cooling water of the battery cooling circuit 5 is less than 40° C. When the temperature T2 of the cooling water of the battery cooling circuit 5 is less than 40° C., a first battery temperature adjustment processing is started. When the temperature T2 of the cooling water of the battery cooling circuit 5 is 40° C. or more, the processing proceeds to step S9 and a first refrigerant cooling processing is started. The first battery temperature adjustment processing is a processing including a battery weak cooling processing. The first refrigerant cooling processing is a processing including a battery strong cooling processing. The processing returns to step S6 when any of step S8 and step S9 is terminated.

In step S10, it is determined whether or not the outside air temperature is more than −30° C. and less than 35° C. When the outside air temperature is more than −30° C. and less than 35° C., the processing proceeds to step S11. When the outside air temperature is not in the range from −30° C. to 35° C., the temperature adjustment processing is terminated. In addition, since the main battery B is not in operation when the outside air temperature is not in the range from −30° C. to 35° C., a processing of not starting the electric motor vehicle may be performed instead of immediately terminating the temperature adjustment processing.

In step S11, it is determined whether or not the power is on. When the power is on, the processing proceeds to step S12. When the power is not on, the temperature adjustment processing is terminated. In step S12, it is determined whether or not the temperature T2 of the cooling water of the battery cooling circuit 5 is less than 40° C. When the temperature T2 of the cooling water of the battery cooling circuit 5 is less than 40° C., the processing proceeds to step S13. When the temperature T2 of the cooling water of the battery cooling circuit 5 is 40° C. or more, the processing proceeds to step S16.

In step S13, it is determined whether or not the temperature T2 of the cooling water of the battery cooling circuit 5 is more than 35° C. When the temperature T2 of the cooling water of the battery cooling circuit 5 is more than 35° C., the processing proceeds to step S14 and a temperature adjustment processing at a low temperature is started. When the temperature T2 of the cooling water of the battery cooling circuit 5 is 35° C. or less, the processing proceeds to step S15 and a second battery temperature adjustment processing is started. The processing returns to step S11 when any of steps S14 to S16 is terminated.

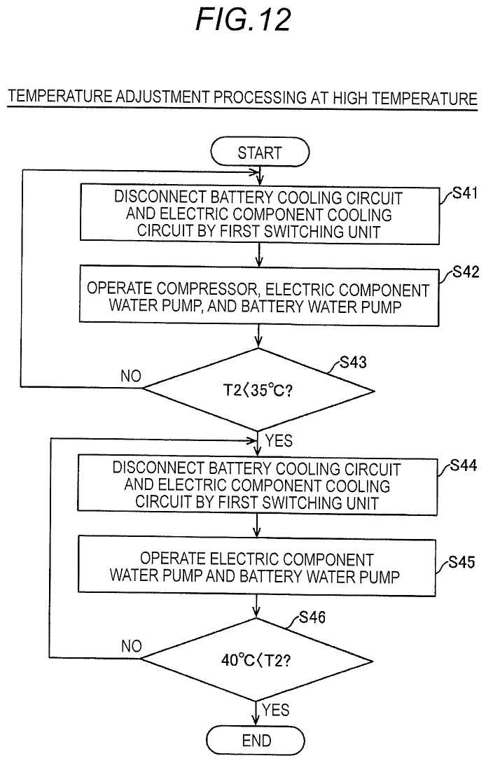

Next, the temperature adjustment processing at a high temperature in step S4 will be described with reference to FIG. 12. The temperature adjustment processing at a high temperature indicates a temperature adjustment processing of adjusting the temperature T1 of the cooling water of the electric component cooling circuit 4 and the temperature T2 of the cooling water of the battery cooling circuit 5 when the outside air temperature is high (about 40° C. or more).

In step S41, the battery cooling circuit 5 and the electric component cooling circuit 4 are disconnected by the first switching unit 2. In step S42, the compressor 21, the electric component water pump 43, and the battery water pump 52 are operated. Thus, heat exchange between the cooling water and the refrigerant of the battery cooling circuit 5 is performed in the battery evaporator 53. In step S43, it is determined whether or not the temperature T2 of the cooling water of the battery cooling circuit 5 is less than 35° C. When the temperature T2 of the cooling water of the battery cooling circuit 5 is more than 35° C., the processing returns to step S41. When the temperature T2 of the cooling water of the battery cooling circuit 5 is less than 35° C., the processing proceeds to step S44.

In step S44, the battery cooling circuit 5 and the electric component cooling circuit 4 are disconnected by the first switching unit 2. In step S45, the electric component water pump 43 and the battery water pump 52 are operated. At this time, the cooling water of the battery cooling circuit 5 circulates only through the battery cooling circuit 5 and at the same time, the cooling water of the electric component cooling circuit 4 circulates only through the electric component cooling circuit 4. In step S46, it is determined whether or not the temperature T2 of the cooling water of the battery cooling circuit 5 is more than 40° C. When the temperature T2 of the cooling water of the battery cooling circuit 5 is more than 40° C., the temperature adjustment processing at a high temperature is immediately terminated. When the temperature T2 of the cooling water of the battery cooling circuit 5 is less than 40° C., the processing returns to step S44.

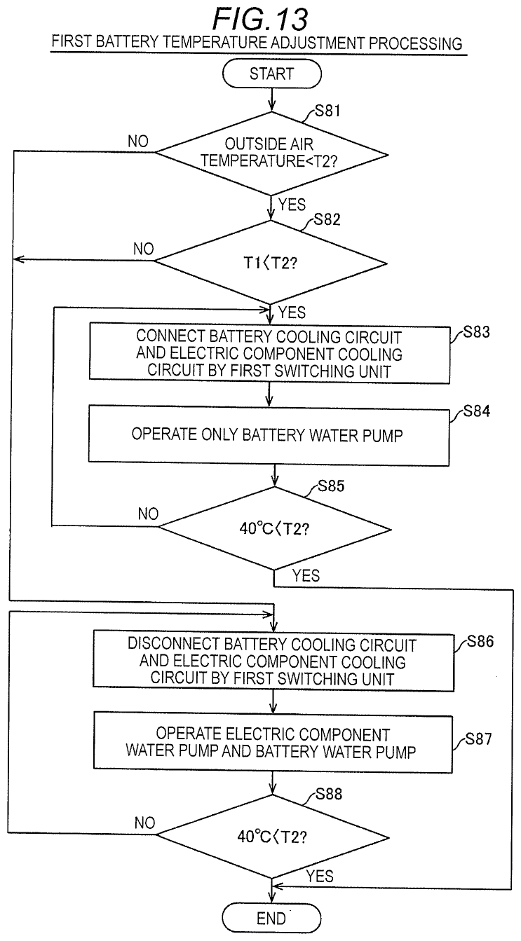

Next, the first battery temperature adjustment processing in step S8 will be described with reference to FIG. 13. The first battery temperature adjustment processing indicates a temperature adjustment processing of adjusting the temperature T2 of the cooling water of the battery cooling circuit 5 using the difference between the temperature T2 of the cooling water of the battery cooling circuit 5 and the temperature T1 of the cooling water of the electric component cooling circuit 4.

In step S81, it is determined whether or not the temperature T2 of the cooling water of the battery cooling circuit 5 is more than the outside air temperature. When the temperature T2 of the cooling water of the battery cooling circuit 5 is more than the outside air temperature, the processing proceeds to step S82. When the temperature T2 of the cooling water of the battery cooling circuit 5 is equal to or less than the outside air temperature, the processing proceeds to step S86. In step S82, it is determined whether or not the temperature T2 of the cooling water of the battery cooling circuit 5 is more than the temperature T1 of the cooling water of the electric component cooling circuit 4. When the temperature T2 of the cooling water of the battery cooling circuit 5 is more than the temperature T1 of the cooling water of the electric component cooling circuit 4, the processing proceeds to step S83. When the temperature T2 of the cooling water of the battery cooling circuit 5 is equal to or less than the temperature T1 of the cooling water of the electric component cooling circuit 4, the processing proceeds to step S86.

In step S83, the battery cooling circuit 5 and the electric component cooling circuit 4 are connected by the first switching unit 2. In step S84, only the battery water pump 52 is operated. At this time, the cooling water of the battery cooling circuit 5 is cooled by the electric component radiator 41 of the electric component cooling circuit 4 by circulating through the electric component cooling circuit 4. In step S85, it is determined whether or not the temperature T2 of the cooling water of the battery cooling circuit 5 is more than 40° C. When the temperature T2 of the cooling water of the battery cooling circuit 5 is more than 40° C., the first battery temperature adjustment processing is immediately terminated. When the temperature T2 of the cooling water of the battery cooling circuit 5 is 40° C. or less, the processing returns to step S83.

In step S86, the battery cooling circuit 5 and the electric component cooling circuit 4 are disconnected by the first switching unit 2. In step S87, the electric component water pump 43 and the battery water pump 52 are operated. At this time, the cooling water of the battery cooling circuit 5 circulates only through the battery cooling circuit 5 and at the same time, the cooling water of the electric component cooling circuit 4 circulates only through the electric component cooling circuit 4. In step S88, it is determined whether or not the temperature T2 of the cooling water of the battery cooling circuit 5 is more than 40° C. When the temperature T2 of the cooling water of the battery cooling circuit 5 is more than 40° C., the first battery temperature adjustment processing is immediately terminated. When the temperature T2 of the cooling water of the battery cooling circuit 5 is 40° C. or less, the processing returns to step S86.

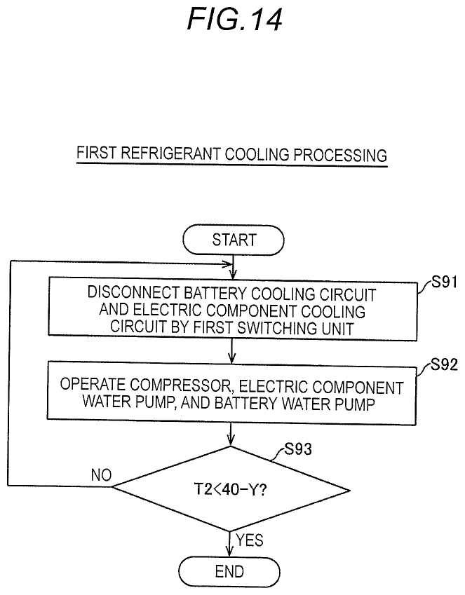

Next, the first refrigerant cooling processing in step S9 will be described with reference to FIG. 14. The first refrigerant cooling processing indicates a temperature adjustment processing of adjusting the temperature T2 of the cooling water of the battery cooling circuit 5 when the outside air temperature is in the second predetermined range (more than 35° C. and less than 40° C.) and at the same time, the temperature T2 of the cooling water of the battery cooling circuit 5 is high (more than about 40° C.).

In step S91, the battery cooling circuit 5 and the electric component cooling circuit 4 are disconnected by the first switching unit 2. In step S92, the compressor 21, the electric component water pump 43, and the battery water pump 52 are operated. Thus, heat exchange between the cooling water and the refrigerant of the battery cooling circuit 5 is performed in the battery evaporator 53. In step S93, it is determined whether or not the temperature T2 of the cooling water of the battery cooling circuit 5 is more than 40° C.—a predetermined value Y. The predetermined value Y is an arbitrarily set value. When the temperature T2 of the cooling water of the battery cooling circuit 5 is less than 40° C.—the predetermined value Y, the temperature adjustment processing is immediately terminated. When the temperature T2 of the cooling water of the battery cooling circuit 5 is equal to or more than 40° C.—the predetermined value Y, the processing returns to step S91.

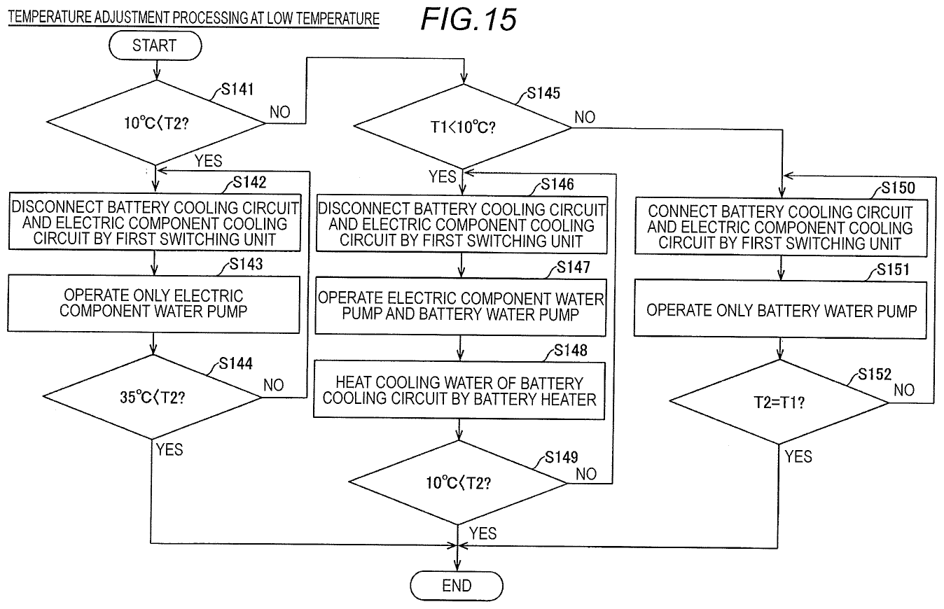

Next, the temperature adjustment processing at a low temperature in step S14 will be described with reference to FIG. 15. The temperature adjustment processing at a low temperature indicates a temperature adjustment processing of adjusting the temperature of the cooling water of the battery cooling circuit 5 with the battery warmed up or not cooled (no cooling).

In step S141, it is determined whether or not the temperature T2 of the cooling water of the battery cooling circuit 5 is more than 10° C. When the temperature T2 of the cooling water of the battery cooling circuit 5 is more than 10° C., the processing proceeds to step S142. When the temperature T2 of the cooling water of the battery cooling circuit 5 is 10° C. or less, the processing proceeds to step S145.

In step S142, the battery cooling circuit 5 and the electric component cooling circuit 4 are disconnected by the first switching unit 2. In step S143, only the electric component water pump 43 is operated. Thus, the battery cooling circuit 5 is only kept warm by heat generated by the main battery B. In step S144, it is determined whether or not the temperature T2 of the cooling water of the battery cooling circuit 5 is more than 35° C. When the temperature T2 of the cooling water of the battery cooling circuit 5 is more than 35° C., the temperature adjustment processing at a low temperature is immediately terminated. When the temperature T2 of the cooling water of the battery cooling circuit 5 is 35° C. or less, the processing returns to step S142.

In step S145, it is determined whether or not the temperature T1 of the cooling water of the electric component cooling circuit 4 is less than 10° C. When the temperature T1 of the cooling water of the electric component cooling circuit 4 is less than 10° C., the processing proceeds to step S146. When the temperature T2 of the cooling water of the battery cooling circuit 5 is 10° C. or more, the processing proceeds to step S150.

In step S146, the battery cooling circuit 5 and the electric component cooling circuit 4 are disconnected by the first switching unit 2. In step S147, the electric component water pump 43 and the battery water pump 52 are operated. In step S148, the cooling water of the battery cooling circuit 5 is heated by the battery heater 54. Thus, the cooling water of the battery cooling circuit 5 is warmed, so that the main battery B is warmed up. In step S149, it is determined whether or not the temperature T2 of the cooling water of the battery cooling circuit 5 is more than 10° C. When the temperature T2 of the cooling water of the battery cooling circuit 5 is more than 10° C., the temperature adjustment processing at a low temperature is immediately terminated. When the temperature T2 of the cooling water of the battery cooling circuit 5 is 10° C. or less, the processing returns to step S146.

In step S150, the battery cooling circuit 5 and the electric component cooling circuit 4 are connected by the first switching unit 2. In step S151, only the battery water pump 52 is operated. Thus, the cooling water of the battery cooling circuit 5 is warmed by the cooling water of the electric component cooling circuit 4 in which waste heat of the inverter E is stored, so that the main battery B is warmed up. In step S152, it is determined whether or not the temperature T2 of the cooling water of the battery cooling circuit 5 and the temperature T1 of the cooling water of the electric component cooling circuit 4 are the same. When the temperature T2 of the cooling water of the battery cooling circuit 5 is the same as the temperature T1 of the cooling water of the electric component cooling circuit 4, the temperature adjustment processing at a low temperature is immediately terminated. When the temperature T2 of the cooling water of the battery cooling circuit 5 differs from the temperature T1 of the cooling water of the electric component cooling circuit 4, the processing returns to step S150.

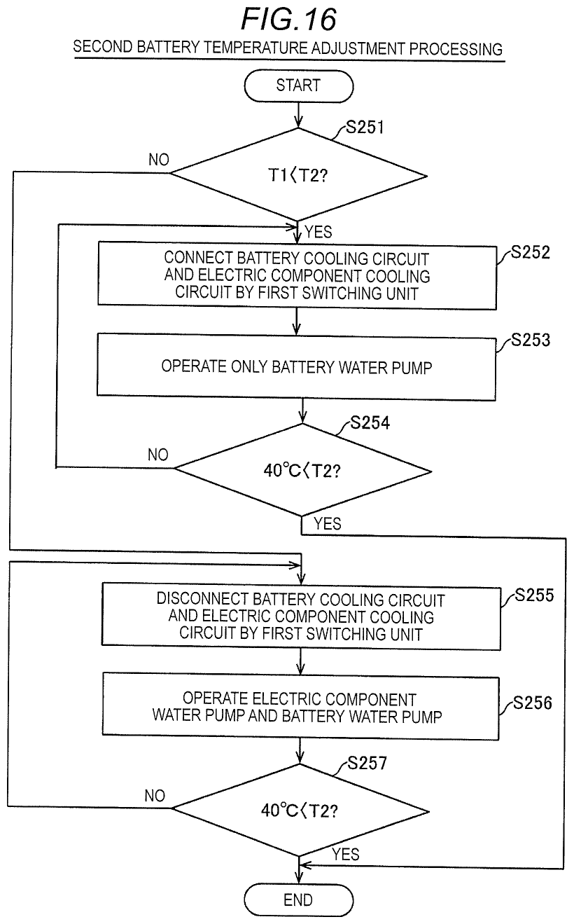

Next, the second battery temperature adjustment processing in step S15 will be described with reference to FIG. 16. The second battery temperature adjustment processing indicates a temperature adjustment processing of adjusting the temperature T2 of the cooling water of the battery cooling circuit 5 using the difference between the temperature of the cooling water of the battery cooling circuit 5 and the temperature of the cooling water of the electric component cooling circuit 4.

In step S251, it is determined whether or not the temperature T2 of the cooling water of the battery cooling circuit 5 is more than the temperature T1 of the cooling water of the electric component cooling circuit 4. When the temperature T2 of the cooling water of the battery cooling circuit 5 is more than the temperature T1 of the cooling water of the electric component cooling circuit 4, the processing proceeds to step S252. When the temperature T2 of the cooling water of the battery cooling circuit 5 is equal to or less than the temperature T1 of the cooling water of the electric component cooling circuit 4, the processing proceeds to step S255.

In step S252, the battery cooling circuit 5 and the electric component cooling circuit 4 are connected by the first switching unit 2. In step S253, only the battery water pump 52 is operated. At this time, the cooling water of the battery cooling circuit 5 is cooled by the electric component radiator 41 of the electric component cooling circuit 4 by circulating through the electric component cooling circuit 4. In step S254, it is determined whether or not the temperature T2 of the cooling water of the battery cooling circuit 5 is more than 40° C. When the temperature T2 of the cooling water of the battery cooling circuit 5 is more than 40° C., the second battery temperature adjustment processing is immediately terminated. When the temperature T2 of the cooling water of the battery cooling circuit 5 is 40° C. or less, the processing returns to step S252.

In step S255, the battery cooling circuit 5 and the electric component cooling circuit 4 are disconnected by the first switching unit 2. In step S256, the electric component water pump 43 and the battery water pump 52 are operated. At this time, the cooling water of the battery cooling circuit 5 circulates only through the battery cooling circuit 5 and the electric component cooling circuit 4. In step S257, it is determined whether or not the temperature T2 of the cooling water of the battery cooling circuit 5 is more than 40° C. When the temperature T2 of the cooling water of the battery cooling circuit 5 is more than 40° C., the second battery temperature adjustment processing is immediately terminated. When the temperature T2 of the cooling water of the battery cooling circuit 5 is 40° C. or less, the processing returns to step S255.

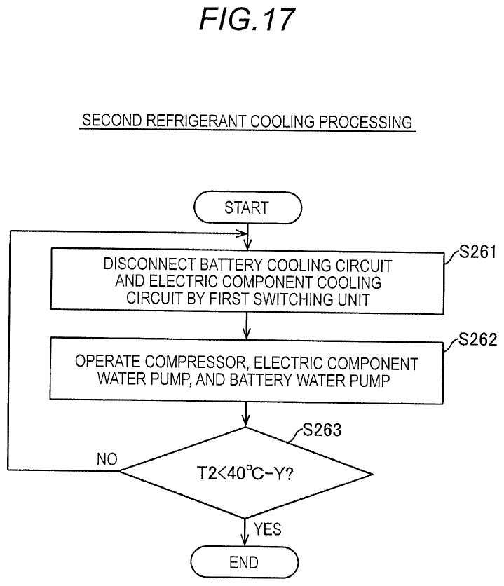

Next, the second refrigerant cooling processing in step S16 will be described with reference to FIG. 17. The second refrigerant cooling processing indicates a temperature adjustment processing of adjusting the temperature T2 of the cooling water of the battery cooling circuit 5 when the outside air temperature is in the first predetermined range (more than −30° C. and less than 35° C.) and at the same time, the temperature T2 of the cooling water of the battery cooling circuit 5 is high (more than about 40° C.).

In step S261, the battery cooling circuit 5 and the electric component cooling circuit 4 are disconnected by the first switching unit 2. In step S262, the compressor 21, the electric component water pump 43, and the battery water pump 52 are operated. Thus, heat exchange between the cooling water and the refrigerant of the battery cooling circuit 5 is performed in the battery evaporator 53. In step S263, it is determined whether or not the temperature T2 of the cooling water of the battery cooling circuit 5 is more than 40° C.—the predetermined value Y. The predetermined value Y is an arbitrarily set value. When the temperature T2 of the cooling water of the battery cooling circuit 5 is less than 40° C. the predetermined value Y, the second refrigerant cooling processing is immediately terminated. When the temperature T2 of the cooling water of the battery cooling circuit 5 is equal to or more than 40° C.—the predetermined value Y, the processing returns to step S261.

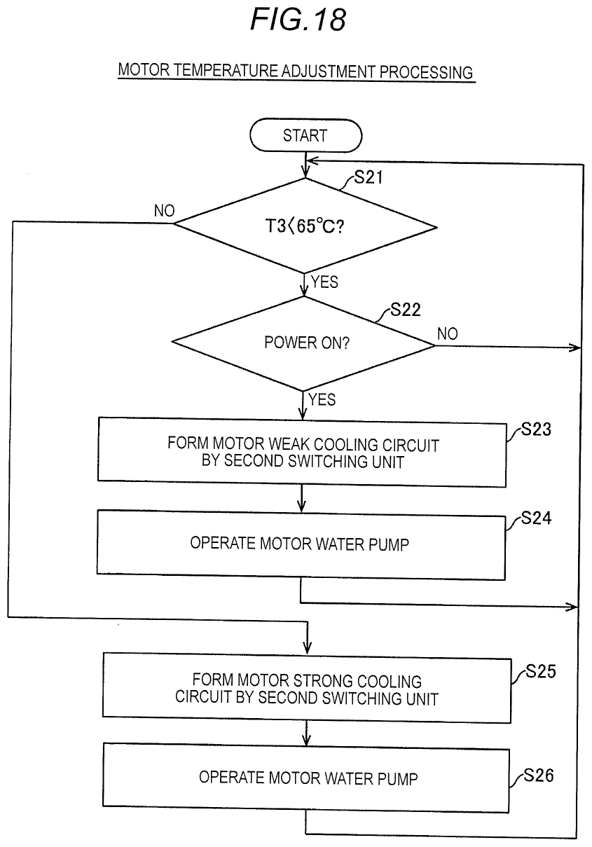

Next, a motor temperature adjustment processing will be described with reference to FIG. 18. The motor temperature adjustment processing indicates a temperature adjustment processing of adjusting the temperature T3 of the cooling water of the motor cooling circuit 3 that is switched to the motor weak cooling circuit M1 and the motor strong cooling circuit M2 based on the threshold value (65° C.).

In step S21, it is determined whether or not the temperature T3 of the cooling water of the motor cooling circuit 3 is less than 65° C. When the temperature T3 of the cooling water of the motor cooling circuit 3 is less than 65° C., the processing proceeds to step S22. When the temperature T3 of the cooling water of the motor cooling circuit 3 is equal to or more than 65° C., the processing proceeds to step S25. In step S22, it is determined whether or not the power is on. When the power is on, the processing proceeds to step S23. When the power is not on, the processing returns to step S21.

In step S23, the second switching unit 34 forms the motor weak cooling circuit M1. In step S24, the motor water pump 31 is operated. Thus, the cooling water circulates in the battery cooling circuit 5. In step S25, the second switching unit 34 forms the motor strong cooling circuit M2. In step S26, the motor water pump 31 is operated. Thus, the cooling water flows into the motor radiator 32 in the battery cooling circuit 5, so that the cooling water of the battery cooling circuit 5 is cooled.

### (Effects of First Embodiment)

In the first embodiment, the following effects may be obtained.

In the first embodiment, as described above, the electric motor vehicle temperature adjustment system 100 is provided with the battery cooling circuit 5, the electric component cooling circuit 4 provided separately from the battery cooling circuit 5, and the motor cooling circuit 3 provided separately from the battery cooling circuit 5 and the electric component cooling circuit 4. Then, the motor cooling circuit 3 and the electric component cooling circuit 4 are arranged independently of each other in a state where the cooling water does not flow therebetween. Thus, instead of cooling the motor M by the cooling water after cooling the inverter E, the motor M may be independently cooled by the motor cooling circuit 3 and at the same time, the inverter E may be independently cooled by the electric component cooling circuit 4, so that the temperature adjustment of the inverter E and the temperature adjustment of the motor M may be performed independently of each other. Therefore, the temperature adjustment of each of the inverter E and the motor M may be separately and easily performed. Further, the battery cooling circuit 5 is also provided separately from the electric component cooling circuit 4 and the motor cooling circuit 3, so that the temperature adjustment of the main battery B may be performed independently of the inverter E and the motor M. As a result, the main battery B may be adjusted to a desired temperature range and at the same time, each of the inverter E and the motor M may be easily adjusted to a separate desired temperature range. Further, by arranging the inverter E and the motor M independently of each other in a state where the cooling water does not flow therebetween, thermal interference between the inverter E and the motor M may be suppressed.

Further, in the first embodiment, as described above, the controller 7 is configured to switch, by the first switching unit 2, whether to operate the compressor 21 and cool the cooling water flowing through the battery cooling circuit 5 by the battery evaporator 53 or to cool the cooling water by the electric component radiator 41 based on the temperatures of both the main battery B and the inverter E. Thus, by switching the cooling water flowing through the battery cooling circuit 5 to the cooling by the electric component radiator 41 rather than the battery evaporator 53 based on the difference between the temperature of the main battery B and the temperature of the inverter E, the cooling water flowing through the battery cooling circuit 5 may be cooled by heat exchange with outside air without using the compressor 21, so that the power consumption of the electric motor vehicle may be reduced.

Further, in the first embodiment, as described above, the air-cooled condenser 22 is disposed adjacent to the electric component radiator 41 in the direction orthogonal to the X direction. Thus, unlike a case where the air-cooled condenser 22 and the electric component radiator 41 are arranged side by side in the X direction, waste heat of the air-cooled condenser 22 may be suppressed from being transferred to the electric component radiator 41 by vehicle-induced airflow upon vehicle traveling, so that deterioration in the cooling performance of the inverter E when the inverter E is cooled by the electric component radiator 41 may be suppressed.

Further, in the first embodiment, as described above, the motor radiator 32 is provided in the motor cooling circuit 3 to cool the motor M and cool the heated cooling water. Thus, the motor M may be cooled by the cooling water cooled by the motor radiator 32 separately from the electric component cooling circuit 4 and the battery cooling circuit 5, so that the motor M may be independently adjusted to a desired temperature range regardless of the temperature adjustment of each of the inverter E and the main battery B.

Further, in the first embodiment, as described above, the electric motor vehicle temperature adjustment system 100 includes the water-cooled condenser 33 that performs heat exchange between the cooling water at the downstream side of the motor radiator 32 in the motor cooling circuit 3 and the refrigerant at the upstream side of the air-cooled condenser 22 in the air conditioning refrigerant circuit 1. Thus, the refrigerant flowing into the air-cooled condenser 22 may be cooled in advance by the water-cooled condenser 33, so that the cooling performance of the air-cooled condenser 22 may be improved.

Further, in the first embodiment, as described above, when the electric component cooling circuit 4 and the battery cooling circuit 5 are switched by the first switching unit 2 so as to be connected to each other, the controller 7 is configured to perform switching, by the third switching unit 44, from the electric component cooling circuit 4 to the electric component cooling circuit 4 that passes through the electric component radiator 41. Thus, the cooling water flowing through the battery cooling circuit 5 may be cooled by the electric component radiator 41 disposed in the electric component cooling circuit 4, so that the inverter E and the main battery B may be cooled in common by the electric component radiator 41. As a result, unlike a case where a device for cooling the cooling water flowing from the battery cooling circuit 5 to the electric component cooling circuit 4 is provided separately from the electric component radiator 41, an increase in the number of components and a complicated configuration of the electric motor vehicle temperature adjustment system 100 may be suppressed.

Further, in the first embodiment, as described above, the air-cooled condenser 22 is disposed adjacent to the electric component radiator 41 in the direction orthogonal to the X direction. Then, the water-cooled condenser 33 is provided in the electric motor vehicle temperature adjustment system 100. Thus, although the cooling performance of the air-cooled condenser 22 decreases since the size of the air-cooled condenser 22 is reduced in the direction orthogonal to the X direction by disposing the air-cooled condenser 22 adjacent to the electric component radiator 41 in the direction orthogonal to the X direction, the refrigerant flowing into the air-cooled condenser 22 may be cooled in advance by the water-cooled condenser 33, so that the cooling performance of the air-cooled condenser 22 may be ensured.

Further, in the first embodiment, the motor radiator 32, the electric component radiator 41, and the air-cooled condenser 22 are arranged side by side in the X direction. Thus, as compared with a case where the motor radiator 32, the electric component radiator 41, and the air-cooled condenser 22 are arranged in three in the X direction, an increased space through which air circulates may be provided between the motor radiator 32, the electric component radiator 41, and the air-cooled condenser 22, so that the cooling performance of each of the motor radiator 32, the electric component radiator 41, and the air-cooled condenser 22 may be improved. As a result, the widths of the motor radiator 32, the electric component radiator 41, and the air-cooled condenser 22 in the direction orthogonal to the X direction may be reduced. Further, since waste heat of the air-cooled condenser 22 is easily transferred to the motor radiator 32 rather than the electric component radiator 41, the influence of the waste heat of the air-cooled condenser 22 on the inverter E having a lower heat resistance than the motor M may be suppressed. As a result, the reliability of the inverter E may be improved.

### [Another Aspect of First Embodiment]

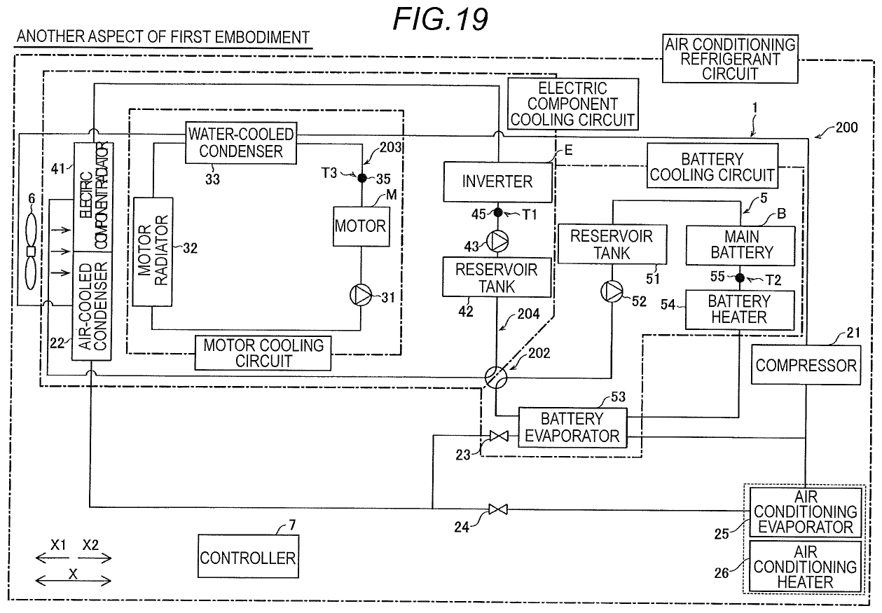

Next, a configuration of an electric motor vehicle temperature adjustment system 200 according to another aspect of the first embodiment disclosed here will be described with reference to FIG. 19. In another aspect of the first embodiment, a description will be given to the electric motor vehicle temperature adjustment system 200 including only a switching unit 202 that switches connection between the battery cooling circuit 5 and an electric component cooling circuit 204 unlike the first embodiment in which the electric motor vehicle temperature adjustment system 100 includes not only the first switching unit 2 that switches the connection between the battery cooling circuit 5 and the electric component cooling circuit 4 but also the second switching unit 34 and the third switching unit 44. In addition, in another aspect of the first embodiment, the same components as those of the first embodiment will be denoted by the same reference numerals and a description thereof will be omitted.

As illustrated in FIG. 19, the electric motor vehicle temperature adjustment system 200 according to another aspect of the first embodiment includes the switching unit 202 (an example of “first switching unit” in the claims), a motor cooling circuit 203, and the electric component cooling circuit 204 instead of the switching unit 2, the motor cooling circuit 3, and the electric component cooling circuit 4 of the first embodiment.

### (Switching Unit, Motor Cooling Circuit, and Electric Component Cooling Circuit)

The switching unit 202 performs switching between connection and disconnection of the battery cooling circuit 5 and the electric component cooling circuit 204. Further, the motor cooling circuit 203 differs from the motor cooling circuit 3 of the first embodiment in that it does not include the second switching unit 34, and the others thereof are the same as those of the motor cooling circuit 3 of the first embodiment. The electric component cooling circuit 204 differs from the electric component cooling circuit 4 of the first embodiment in that it does not include the third switching unit 44, and the others thereof are the same as those of the electric component cooling circuit 4 of the first embodiment.

The controller 7 is configured to perform the battery weak cooling processing or the battery strong cooling processing based on the temperature T1 of the electric component temperature sensor 45 of the electric component cooling circuit 204 and the temperature T2 of the battery temperature sensor 55 of the battery cooling circuit 5. Further, the controller 7 is configured to perform a motor cooling processing based on the temperature T3 of the motor temperature sensor 35 of the motor cooling circuit 203. In addition, the other configuration of another aspect of the first embodiment is the same as the configuration of the first embodiment.

### (Effect of Other Aspect of First Embodiment)

In another aspect of the first embodiment, the following effects may be obtained.

In another aspect of the first embodiment, as described above, the motor cooling circuit 203 and the electric component cooling circuit 204 are arranged independently of each other in a state where the cooling water does not flow therebetween. Thus, the main battery B may be adjusted to a desired temperature range and at the same time, each of inverter E and motor M may be easily adjusted to a separate desired temperature range.

Further, in another aspect of the first embodiment, as described above, the switching unit 202 is provided in the electric motor vehicle temperature adjustment system 200 to switch the connection between the battery cooling circuit 5 and the electric component cooling circuit 204. Thus, the switching unit 202 may perform switching between the battery weak cooling processing and the battery strong cooling processing alone, so that a simplified configuration of the electric motor vehicle temperature adjustment system 200 may be easily achieved. In addition, other effects of another aspect of the first embodiment are the same as the effects of the first embodiment.

### Second Embodiment

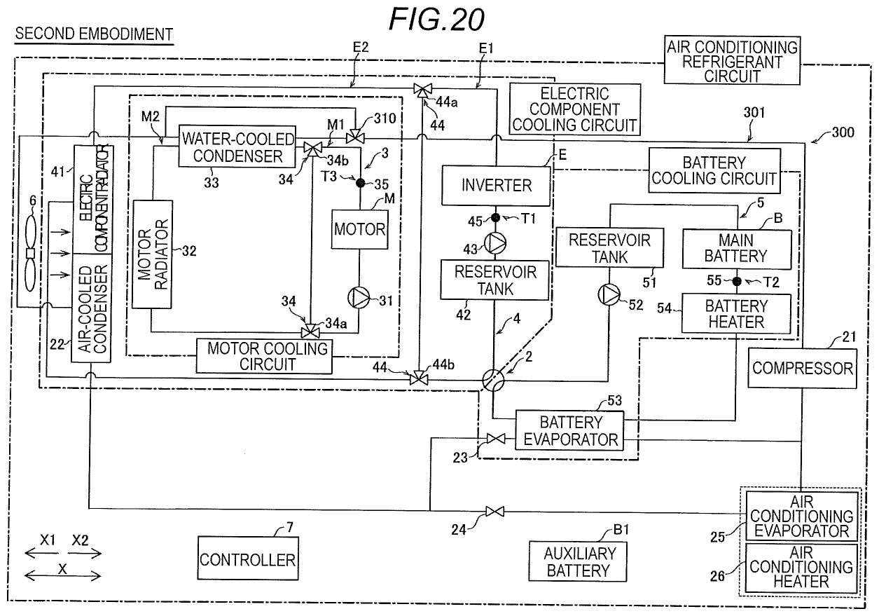

Next, a configuration of an electric motor vehicle temperature adjustment system 300 according to a second embodiment disclosed here will be described with reference to FIG. 20. In the second embodiment, a description will be given to the electric motor vehicle temperature adjustment system 300 including a switching valve 310 disposed between the compressor 21 and the water-cooled condenser 33 unlike the first embodiment in which the electric motor vehicle temperature adjustment system 100 does not include a switching valve between the compressor 21 and the water-cooled condenser 33 in the air conditioning refrigerant circuit 1. In addition, in the second embodiment, the same components as those in the first embodiment will be denoted by the same reference numerals, and a description thereof will be omitted.

As illustrated in FIG. 20, the electric motor vehicle temperature adjustment system 300 of the second embodiment includes an air conditioning refrigerant circuit 301 instead of the air conditioning refrigerant circuit 1 of the first embodiment. The air conditioning refrigerant circuit 301 differs from the air conditioning refrigerant circuit 1 of the first embodiment in that it further includes a switching valve 310.

The air conditioning refrigerant circuit 301 of the second embodiment is configured to switch, by the switching valve 310, whether to flow the refrigerant to the air-cooled condenser 22 through the water-cooled condenser 33 or to flow the refrigerant to the air-cooled condenser 22 without passing through the water-cooled condenser 33. The switching valve 310 is configured to perform switching between connection and disconnection of the compressor 21 and the water-cooled condenser 33. The switching valve 310 is configured by a three-way valve.

### (Controller)

The controller 7 is configured to control the temperatures of the motor M, the inverter E, and the main battery B based on the temperature T3 of the motor temperature sensor 35 of the motor cooling circuit 3, the temperature T1 of the electric component temperature sensor 45 of the electric component cooling circuit 4, and the temperature T2 of the battery temperature sensor 55 of the battery cooling circuit 5.

The controller 7 of the second embodiment is configured to switch the circuit by the switching valve 310 by comparing the temperature of the refrigerant flowing out of the compressor 21 with the temperature of the cooling water flowing out of the motor radiator 32 of the motor cooling circuit 3. Specifically, the controller 7 is configured to perform control to switch the switching valve 310 so that the compressor 21 and the water-cooled condenser 33 are disconnected when the temperature of the cooling water flowing out of the motor radiator 32 of the motor cooling circuit 3 is more than the temperature of the refrigerant flowing out of the compressor 21. Further, the controller 7 is configured to perform control to switch the switching valve 310 so that the compressor 21 and the water-cooled condenser 33 are connected when the temperature of the cooling water flowing out of the motor radiator 32 of the motor cooling circuit 3 is less than the temperature of the refrigerant flowing out of the compressor 21. In addition, the other configuration of the second embodiment is the same as the configuration of the first embodiment.

### (Effect of Second Embodiment)

In the second embodiment, the following effects may be obtained.

In the second embodiment, as described above, the motor cooling circuit 3 and the electric component cooling circuit 4 are arranged independently of each other in a state where the cooling water does not flow therebetween. Thus, the main battery B may be adjusted to a desired temperature range and at the same time, each of inverter E and motor M may be easily adjusted to a separate desired temperature range.

Further, in the second embodiment, as described above, the controller 7 is configured to perform control to switch the switching valve 310 so that the compressor 21 and the water-cooled condenser 33 are connected when the temperature of the cooling water flowing out of the motor radiator 32 of the motor cooling circuit 3 is less than the temperature of the refrigerant flowing out of the compressor 21. Thus, the refrigerant flowing out of the compressor 21 may be reliably cooled by the cooling water, so that deterioration in the cooling performance of the air-cooled condenser 22 may be suppressed. In addition, the other effects of the second embodiment are the same as the effects of the first embodiment.

### [Modification]

The embodiments disclosed here are to be considered in all respects as illustrative and not restrictive. The scope of this disclosure is defined by the terms of the claims rather than the description of the embodiments, and further includes all modifications (alterations) within the scope and meaning equivalent to the terms of the claims.

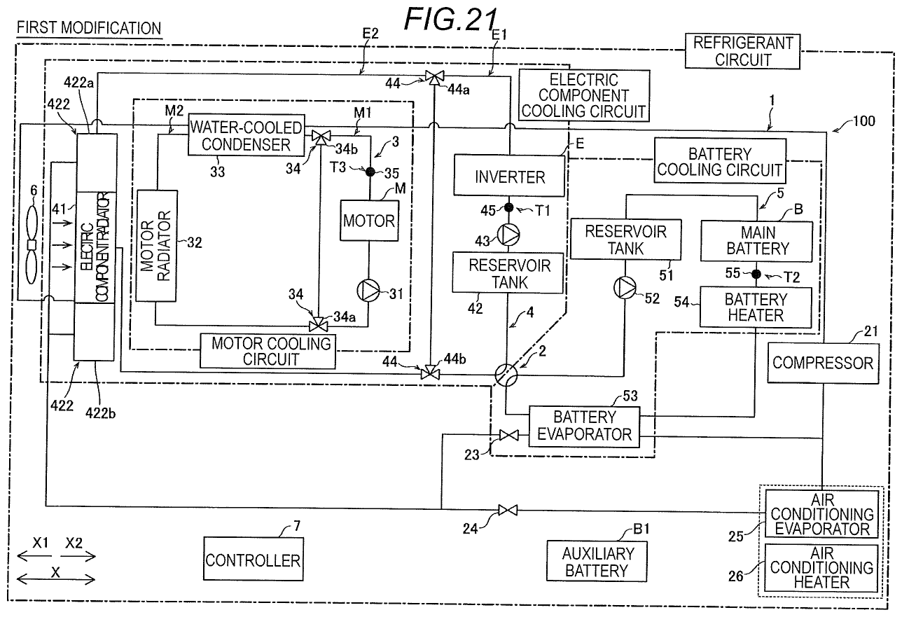

For example, in the first and second embodiments, the example in which the air-cooled condenser 22 is disposed adjacent to the electric component radiator 41 in the direction orthogonal to the X direction among the horizontal direction has been described, but this disclosure is not limited thereto. In this disclosure, as in a first modification illustrated in FIG. 21, the air-cooled condenser 422 may include a first condenser part 422a adjacent to one side of the electric component radiator 41 and a second condenser part 422b adjacent to the other side of the electric component radiator 41 in the direction orthogonal to the X direction among the horizontal direction. Thus, by dividing the air-cooled condenser 22 into the first condenser part 422a and the second condenser part 422b, the influence of the waste heat of the air-cooled condenser 22 from the air-cooled condenser 22 to the motor radiator 32 may be reduced.

Further, in the first and second embodiments, the example in which the first switching unit 2 (202) includes a four-way valve has been described, but this disclosure is not limited thereto. In this disclosure, the first switching unit may realize the same control operation as in a case where the four-way valve is applied by controlling a plurality of on-off valves in cooperation.

Further, in the first and second embodiments, the example in which the first motor switching valve 34a and the second motor switching valve 34b constituting the second switching unit 34 are configured by three-way valves has been described, but this disclosure is not limited thereto. In this disclosure, the second switching unit may realize the same control operation as in a case where the three-way valve is applied by controlling a plurality of on-off valves in cooperation.

Further, in the first and second embodiments, the example in which the first electric component switching valve 44a and the second electric component switching valve 44b constituting the third switching unit 44 are configured by three-way valves has been described, but this disclosure is not limited thereto. In this disclosure, the third switching unit may realize the same control operation as in a case where a three-way valve is applied by controlling a plurality of on-off valves in cooperation.

Further, in the second embodiment, the example in which the switching valve 310 is configured by a three-way valve has been described, but this disclosure is not limited thereto. In this disclosure, the switching valve may realize the same control operation as in a case where a three-way valve is applied by controlling a plurality of on-off valves in cooperation.

Further, in the first embodiment, another aspect of the first embodiment, and the second embodiment, the electric vehicle has been described as an example of the electric motor vehicle to which the electric motor vehicle temperature adjustment system 100 (200 or 300) is applied, but this disclosure is not limited thereto. In this disclosure, the electric motor vehicle temperature adjustment system may be applied to a hybrid vehicle having a drive motor and an engine, a plug-in hybrid vehicle, and a vehicle having a range extender.

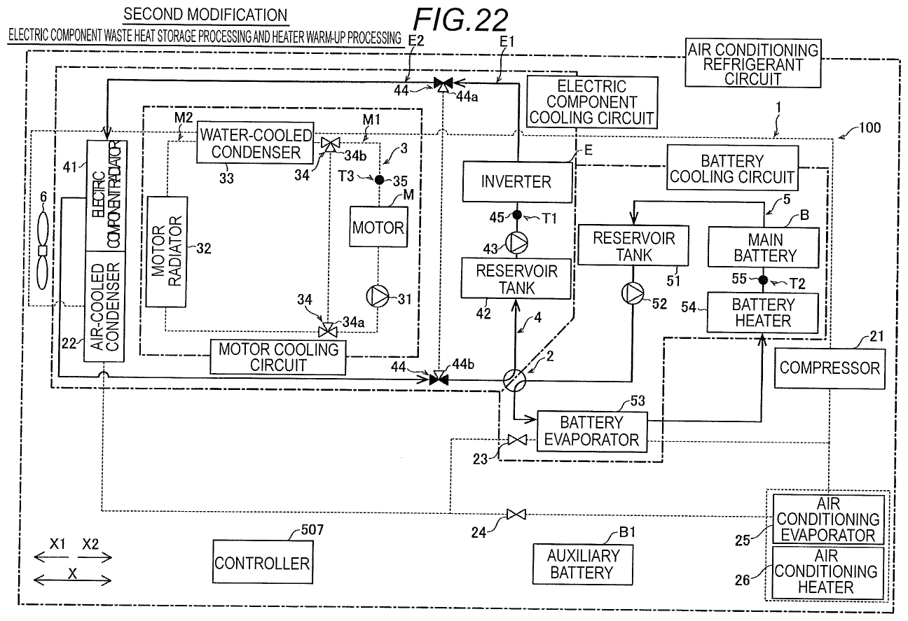

Further, in the first embodiment, as illustrated in FIG. 2, the example in which, when performing both the electric component waste heat storage processing and the heater warm-up processing, the controller 7 controls the first switching unit 2 to disconnect the battery cooling circuit 4 and the electric component cooling circuit 4 and at the same time, controls the third switching unit 44 to perform switching from the electric component cooling circuit 4 to the electric component waste heat storage circuit E1 has been described, but this disclosure is not limited thereto. For example, as in a second modification illustrated in FIG. 22, when performing both the electric component waste heat storage processing and the heater warm-up processing, a controller 507 may be configured to control the first switching unit 2 to disconnect the battery cooling circuit 5 and the electric component cooling circuit 4 and at the same time, to control the third switching unit 44 to perform switching from the electric component cooling circuit 4 the electric component cooling circuit E2, in a state where an operation of the blower 6 is stopped. In this case, since the operation of the blower 6 is stopped, the heat of the inverter E may be stored in the cooling water.

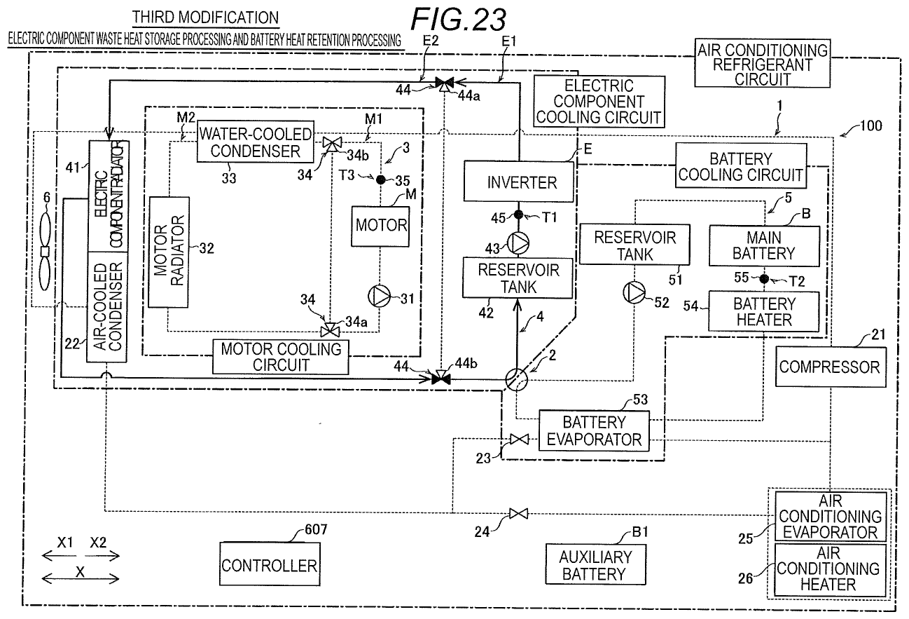

Further, in the first embodiment, as illustrated in FIG. 3, the example in which, when performing both the electric component waste heat storage processing and the battery warm-up processing, the controller 7 controls the first switching unit 2 to disconnect the battery cooling circuit 5 and the electric component cooling circuit 4 and at the same time, controls by the third switching unit 44 to perform switching from the electric component cooling circuit 4 to the electric component waste heat storage circuit E1 has been described, but this disclosure is not limited thereto. For example, as in a third modification illustrated in FIG. 23, when performing both the electric component waste heat storage processing and the battery heat retention processing, a controller 607 may be configured to control the first switching unit 2 to disconnect the battery cooling circuit 5 and the electric component cooling circuit 4 and at the same time, to control the third switching unit 44 to perform switching from the electric component cooling circuit 4 to the electric component cooling circuit E2, in a state where an operation of the blower 6 is stopped. In this case, since the operation of the blower 6 is stopped, the heat of the inverter E may be stored in the cooling water.

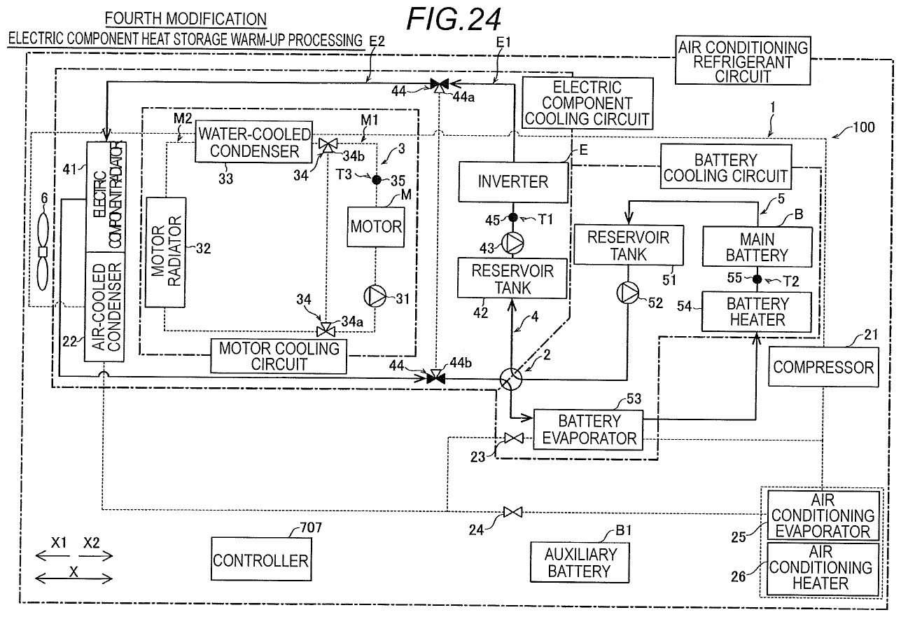

Further, in the first embodiment, as illustrated in FIG. 4, the example in which, when performing the electric component heat storage warm-up processing, the controller 7 controls the first switching unit 2 to connect the battery switching circuit 5 and the electric component cooling circuit 4 and at the same time, controls the third switching unit 44 to perform switching from the electric component cooling circuit 4 to the electric component waste heat storage circuit E1, but this disclosure is not limited thereto. For example, as in a fourth modification illustrated in FIG. 24, when performing the electric component heat storage warm-up processing, a controller 707 may be configured to control the first switching unit 2 to connect the battery cooling circuit 5 and the electric component cooling circuit 4 and at the same time, to control the third switching unit 44 to perform switching from the electric component cooling circuit 4 to the electric component cooling circuit E2, in a state where an operation of the blower 6 is stopped. In this case, since the operation of the blower 6 is stopped, the main battery B may be warmed by the cooling water storing the heat of the inverter E.

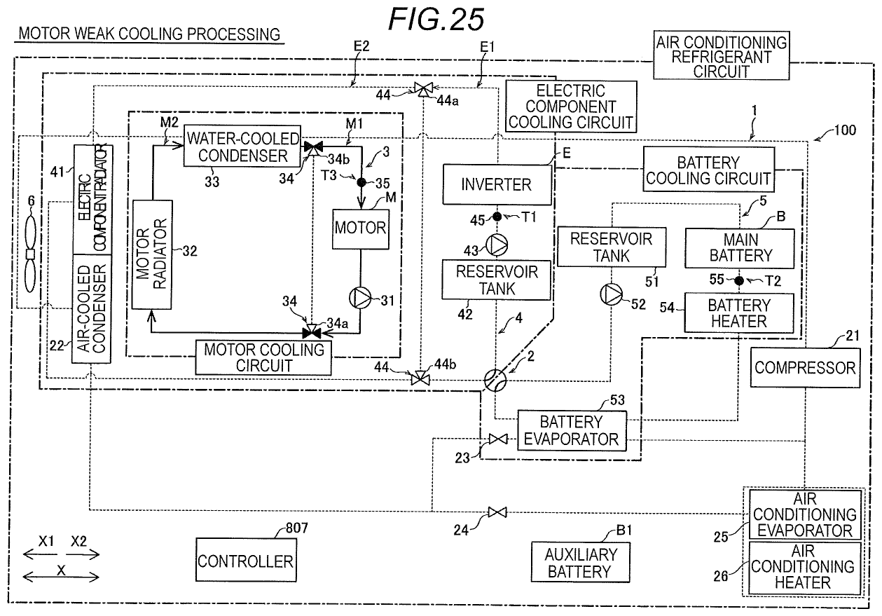

Further, in the first embodiment, as illustrated in FIG. 7, the example in which, when performing the motor weak cooling processing, the controller 7 controls the second switching unit 34 to perform switching from the motor cooling circuit 3 to the motor weak cooling circuit M1 to cool the motor M has been described, but this disclosure is not limited thereto. For example, the controller may control the second switching unit to perform switching from the motor cooling circuit to the motor weak cooling circuit to warm up the motor. Further, as a method of warming up the motor, as in a fifth modification illustrated in FIG. 25, a controller 807 may control the second switching unit 34 to perform switching from the motor cooling circuit 3 to the motor strong cooling circuit M2 in a state where an operation of the blower 6 is stopped to warm up the motor. Further, as a method of warming up the motor, the controller may perform control for warming up the motor in a state where operations of both the blower and the motor water pump are stopped.

Further, in the first embodiment, for convenience of explanation, the example in which a control processing of the controller 7 is described using a flow-driven flowchart in which processings are sequentially performed along a processing flow has been described, but this disclosure is not limited thereto. In this disclosure, the control processing of the controller may be performed by an event-driven processing of executing processings in event unit. In this case, the control processing may be performed in a completely event-driven manner, or may be performed in a combination of event-driven and flow-driven manners.

An electric motor vehicle temperature adjustment system according to an aspect of this disclosure includes an air conditioning refrigerant circuit including a compressor configured to compress a refrigerant, an air conditioning evaporator provided upstream of the compressor, and an air-cooled condenser configured to condense the refrigerant flowing out of the compressor with outside air, the air conditioning refrigerant circuit being configured to flow the refrigerant that cools air-conditioning air, a battery cooling circuit including a battery evaporator and configured to flow cooling water that cools a main battery provided separately from an auxiliary battery, an electric component cooling circuit provided separately from the battery cooling circuit, including an electric component radiator, and configured to flow cooling water that cools an electric component, a first switching unit configured to perform switching between connection and disconnection of the battery cooling circuit and the electric component cooling circuit, and a motor cooling circuit provided separately from the battery cooling circuit and the electric component cooling circuit and configured to flow cooling water that cools a motor, wherein the motor cooling circuit and the electric component cooling circuit are arranged independently of each other in a state where the cooling water does not flow therebetween. Here, an electric motor vehicle is a broad concept including not only an electric vehicle but also a hybrid vehicle having a drive motor and an engine, a plug-in hybrid vehicle, and a vehicle having a range extender.

As described above, the electric motor vehicle temperature adjustment system according to the aspect of this disclosure is provided with the battery cooling circuit, the electric component cooling circuit provided separately from the battery cooling circuit, and the motor cooling circuit provided separately from the battery cooling circuit and the electric component cooling circuit. Then, the motor cooling circuit and the electric component cooling circuit are arranged independently of each other in a state where the cooling water does not flow therebetween. Thus, instead of cooling the motor by the cooling water after cooling the electric component, the motor may be independently cooled by the motor cooling circuit and at the same time, the electric component may be independently cooled by the electric component cooling circuit, so that the temperature adjustment of the electric component and the temperature adjustment of the motor may be performed independently of each other. Therefore, the temperature adjustment of each of the electric component and the motor may be separately and easily performed. Further, the battery cooling circuit is also provided separately from the electric component cooling circuit and the motor cooling circuit, so that the temperature adjustment of the battery may be performed independently of the electric component and the motor. As a result, the battery may be adjusted to a desired temperature range and at the same time, each of the electric component and the motor may be easily adjusted to a separate desired temperature range. Further, by arranging the electric component and the motor independently of each other in a state where the cooling water does not flow therebetween, thermal interference between the electric component and the motor may be suppressed.

It is preferable that the electric motor vehicle temperature adjustment system according to the aspect is configured to switch, by the first switching unit, whether to operate the compressor and cool the cooling water flowing through the battery cooling circuit by the battery evaporator or to cool the cooling water by the electric component radiator based on temperatures of both the battery and the electric component.

With this configuration, by switching the cooling water flowing through the battery cooling circuit to the cooling by the electric component radiator rather than the battery evaporator based on the temperature of the battery and the temperature of the electric component, the cooling water flowing through the battery cooling circuit may be cooled by heat exchange with outside air without using the compressor, so that the power consumption of the electric motor vehicle may be reduced.

In the electric motor vehicle temperature adjustment system according to the aspect, it is preferable that the air-cooled condenser is disposed adjacent to the electric component radiator in a direction orthogonal to a vehicle longitudinal direction.

With this configuration, unlike a case where the air-cooled condenser and the electric component radiator are arranged side by side in the vehicle longitudinal direction, waste heat of the air-cooled condenser may be suppressed from being transferred to the electric component radiator by vehicle-induced airflow upon vehicle traveling, so that deterioration in the cooling performance of the electric component when the electric component is cooled by the electric component radiator may be suppressed.

In the electric motor vehicle temperature adjustment system according to the aspect, it is preferable that the motor cooling circuit includes a motor radiator configured to cool the motor and cool the heated cooling water.

With this configuration, the motor may be cooled by the cooling water cooled by the motor radiator separately from the electric component cooling circuit and the battery cooling circuit, so that the motor may be independently adjusted to a desired temperature range regardless of the temperature adjustment of each of the electric component and the battery.

In this case, it is preferable that the electric motor vehicle temperature adjustment system further includes a water-cooled condenser configured to perform heat exchange between the cooling water at a downstream side of the motor radiator in the motor cooling circuit and the refrigerant at an upstream side of the air-cooled condenser in the air conditioning refrigerant circuit.

With this configuration, the refrigerant flowing into the air-cooled condenser may be cooled in advance by the water-cooled condenser, so that the cooling performance of the air-cooled condenser may be improved.

It is preferable that the electric motor vehicle temperature adjustment system according to the aspect further includes a second switching unit provided in the electric component cooling circuit to perform switching between a first cooling circuit that does not pass through the electric component radiator and a second cooling circuit that passes through the electric component radiator, and when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

With this configuration, the cooling water flowing through the battery cooling circuit may be cooled by the electric component radiator disposed in the second cooling circuit, so that the electric component and the main battery may be cooled in common by the electric component radiator. As a result, unlike a case where a device for cooling the cooling water flowing from the battery cooling circuit to the second cooling circuit is provided separately from the electric component radiator, an increase in the number of components and a complicated configuration of the electric motor vehicle temperature adjustment system may be suppressed.

In addition, in the electric motor vehicle temperature adjustment system according to the aspect, the following configuration is conceivable.

### (Appendix 1)

That is, in the electric motor vehicle temperature adjustment system according to the aspect, the battery evaporator is provided across the air conditioning refrigerant circuit and the battery cooling circuit, and is configured to evaporate the refrigerant in the air conditioning refrigerant circuit by heat of the cooling water in the battery cooling circuit.

With this configuration, as compared with a case where the cooling water in the battery cooling circuit is cooled by heat exchange with the outside air, the cooling performance of the cooling water in the battery cooling circuit may be improved, so that an excessive increase in the temperature of the cooling water in the battery cooling circuit may be effectively suppressed.

### (Appendix 2)

In the electric motor vehicle temperature adjustment system according to the aspect, the battery cooling circuit includes a first electric motor pump configured to circulate the cooling water of the battery cooling circuit, and the electric component cooling circuit includes a second electric motor pump configured to circulate the cooling water of the electric component cooling circuit.

With this configuration, even in an electric motor vehicle having no engine, the cooling water of each of the battery cooling circuit and the electric component cooling circuit may be easily circulated.

### (Appendix 3)

In the electric motor vehicle temperature adjustment system according to the aspect, the first switching unit is configured by a four-way valve.

With this configuration, the number of components of the first switching unit may be reduced, so that an increase in size and the complexity of the configuration of the electric motor vehicle temperature adjustment system may be suppressed.

### (Appendix 4)

In the electric motor vehicle temperature adjustment system according to the aspect, the battery cooling circuit includes a heater disposed at an upstream side of the battery.

With this configuration, by heating the cooling water of the battery cooling circuit with the heater, the battery may be warmed up in a cold area and in winter, so that the battery may be maintained at an optimum temperature.

### (Appendix 5)

In the electric motor vehicle temperature adjustment system including the second switching unit that performs switching between the first cooling circuit and the second cooling circuit, when the electric component cooling circuit and the battery cooling circuit are switched by the first switching unit so as to be connected to each other, the electric component cooling circuit may be configured so as to be switched, by the second switching unit, to the first cooling circuit that does not pass through the electric component radiator.

With this configuration, the cooling water of the electric component cooling circuit storing the waste heat of the electric component may be supplied to the battery cooling circuit, so that the battery may be warmed up without using a configuration that requires electric power such as a heater. As a result, the electric power consumption of the electric motor vehicle may be further reduced.

### (Appendix 6)

The electric motor vehicle temperature adjustment system having the motor radiator further includes a third switching unit provided in the motor cooling circuit to perform switching between a third cooling circuit that passes through the motor radiator and a fourth cooling circuit that does not pass through the motor radiator.

With this configuration, the heating of the cooling water of the motor cooling circuit and the cooling of the cooling water of the motor cooling circuit may be switched by the third switching unit, so that the motor may be maintained at an optimum temperature. Further, at the time of a cold start, the cooling water does not flow to the motor radiator by switching from the third cooling circuit to the fourth cooling circuit by the third switching unit, so that the motor may be suppressed from being excessively cooled.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An electric motor vehicle temperature adjustment system comprising:
an air conditioning refrigerant circuit including a compressor configured to compress a refrigerant, an air conditioning evaporator provided upstream of the compressor, and an air-cooled condenser configured to condense the refrigerant flowing out of the compressor with outside air, the air conditioning refrigerant circuit being configured to flow the refrigerant that cools air-conditioning air;
a battery cooling circuit including a battery evaporator and configured to flow cooling water that cools a main battery provided separately from an auxiliary battery;
an electric component cooling circuit provided separately from the battery cooling circuit, including an electric component radiator, and configured to flow cooling water that cools an electric component;
a first switching unit configured to perform switching between connection and disconnection of the battery cooling circuit and the electric component cooling circuit; and
a motor cooling circuit provided separately from the battery cooling circuit and the electric component cooling circuit and configured to flow cooling water that cools a motor, wherein
the motor cooling circuit and the electric component cooling circuit are arranged independently of each other in a state where the cooling water does not flow therebetween.

2. The electric motor vehicle temperature adjustment system according to claim 1, wherein
the electric motor vehicle temperature adjustment system is configured to switch, by the first switching unit, whether to operate the compressor and cool the cooling water flowing through the battery cooling circuit by the battery evaporator or to cool the cooling water by the electric component radiator based on temperatures of both the main battery and the electric component.

3. The electric motor vehicle temperature adjustment system according to claim 1, wherein
the air-cooled condenser is disposed adjacent to the electric component radiator in a direction orthogonal to a vehicle longitudinal direction.

4. The electric motor vehicle temperature adjustment system according to claim 2, wherein
the air-cooled condenser is disposed adjacent to the electric component radiator in a direction orthogonal to a vehicle longitudinal direction.

5. The electric motor vehicle temperature adjustment system according to claim 1, wherein
the motor cooling circuit includes a motor radiator configured to cool the motor and cool the heated cooling water.

6. The electric motor vehicle temperature adjustment system according to claim 5, further comprising:
a water-cooled condenser configured to perform heat exchange between the cooling water at a downstream side of the motor radiator in the motor cooling circuit and the refrigerant at an upstream side of the air-cooled condenser in the air conditioning refrigerant circuit.

7. The electric motor vehicle temperature adjustment system according to claim 1, further comprising
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

8. The electric motor vehicle temperature adjustment system according to claim 2, further comprising
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

9. The electric motor vehicle temperature adjustment system according to claim 3, further comprising
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

10. The electric motor vehicle temperature adjustment system according to claim 5, further comprising
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

11. The electric motor vehicle temperature adjustment system according to claim 6, further comprising
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the second cooling circuit that passes through the electric component radiator.

12. The electric motor vehicle temperature adjustment system according to claim 1, wherein
the battery evaporator is provided across the air conditioning refrigerant circuit and the battery cooling circuit, and is configured to evaporate the refrigerant in the air conditioning refrigerant circuit by heat of the cooling water in the battery cooling circuit.

13. The electric motor vehicle temperature adjustment system according to claim 2, wherein
the battery evaporator is provided across the air conditioning refrigerant circuit and the battery cooling circuit, and is configured to evaporate the refrigerant in the air conditioning refrigerant circuit by heat of the cooling water in the battery cooling circuit.

14. The electric motor vehicle temperature adjustment system according to claim 1, wherein
the battery cooling circuit includes a first electric motor pump configured to circulate the cooling water of the battery cooling circuit, and the electric component cooling circuit includes a second electric motor pump configured to circulate the cooling water of the electric component cooling circuit.

15. The electric motor vehicle temperature adjustment system according to claim 1, wherein
the first switching unit is configured by a four-way valve.

16. The electric motor vehicle temperature adjustment system according to claim 1, wherein
the battery cooling circuit includes a heater disposed at an upstream side of the main battery.

17. The electric motor vehicle temperature adjustment system according to claim 7, wherein
when the electric component cooling circuit and the battery cooling circuit are switched by the first switching unit so as to be connected to each other, the electric component cooling circuit is configured so as to be switched, by the second switching unit, to the first cooling circuit that does not pass through the electric component radiator.

18. The electric motor vehicle temperature adjustment system according to claim 1, further comprising:
a second switching unit provided in the electric component cooling circuit to perform switching between a first cooling circuit that does not pass through the electric component radiator and a second cooling circuit that passes through the electric component radiator, wherein
when the electric component cooling circuit and the battery cooling circuit are switched by the first switching unit so as to be connected to each other, the electric component cooling circuit is configured so as to be switched, by the second switching unit, to the first cooling circuit that does not pass through the electric component radiator.

19. The electric motor vehicle temperature adjustment system according to claim 5, wherein
the motor cooling circuit includes a motor radiator configured to cool the motor and cool the heated cooling water, and
the electric motor vehicle temperature adjustment system further comprises a third switching unit provided in the motor cooling circuit to perform switching between a third cooling circuit that passes through the motor radiator and a fourth cooling circuit that does not pass through the motor radiator.
